(19) United States
(12) Patent Application Publication
(10) Pub. No.: US 2022/0261006 A1
(43) Pub. Date: Aug. 18, 2022

(54) AUTONOMOUS WOOD DECK MAINTENANCE APPARATUS

(71) Applicant: ROBODECK LTD., Kfar Sirkin (IL)

(72) Inventors: Ran ZASLAVSKY, Kfar Saba (IL); Gal FRENKEL, Elkana (IL); Eli SHRAGA, Elakana (IL); Rom SAAR, Kfar Sirkin (IL); Shelly BURDA, Kfar Sirkin (IL); Michael LAYANI, Petach Tiqwa (IL)

(21) Appl. No.: 17/625,828

(22) PCT Filed: Jul. 9, 2020
(86) PCT No.: PCT/IB2020/056473

§ 371 Date: Jan. 10, 2022

Related U.S. Application Data
(60) Provisional application No. 62/871,772, filed on Jul. 9, 2019.

(51) Int. Cl. G05D 1/02; B05B 13/00; A47L 11/40

(52) U.S. Cl. CPC G05D 1/0242; B05B 13/005; G05D 1/0246; A47L 11/4011; A47L 2201/04; A47L 11/4088; A47L 11/4083; G05D 2201/0203; G05D 1/0274; A47L 11/4002

(57) ABSTRACT

An autonomous apparatus, such as an autonomous robot, maintains wood decks by automatically cleaning and staining the deck while traversing the deck in a manner so that the cleaning and staining is performed in accordance with an organized navigation pattern along the deck boards.

### CROSS-REFERENCES TO RELATED APPLICATIONS

This application is related to and claims priority from commonly owned U.S. Provisional Patent Application Ser. No. 62/871,772, entitled: Autonomous Wood Deck Maintenance Apparatus, filed on Jul. 9, 2019, the disclosure of which is incorporated herein in its entirety.

### TECHNICAL FIELD

The present disclosure relates to autonomous machines for operating on wood decks, and in particular to autonomous machines that clean and maintain wood decks.

### BACKGROUND

Wood or timber “decking” is typically used as part of garden landscaping, to extend living areas of houses, and as an alternative to stone based features such as patios. Wood Decks are typically made from treated lumber and composite lumber, with the lumber including western red cedar, teak, mahogany, and other hardwoods. Wood decks are now commonplace in residential construction, as well as in commercial construction, such as in parks and gardens.

While these wood decks are highly aesthetic, they require constant maintenance. This maintenance includes cleaning, staining and sanding, at various times during the life of the deck. Currently, all of these maintenance procedures are performed manually, which is expensive and time consuming. The maintenance treatment usually involves a two-step process; the first step including manual cleaning performed using a high pressure cleaning apparatus, which is operated by a human and the second step including manual staining, by a human. This process may be performed several times a year due to the wear on the deck, caused by the local climate, including, seasonal temperature changes, amounts of exposure to sunlight and associated radiation, humidity, and rain, as well as traffic on the deck, all of which add to the wear on the deck.

### SUMMARY OF THE DISCLOSURE

The present disclosure is directed to an autonomous apparatus that maintains wood decks by automatically cleaning and staining the deck while traversing the deck in a manner so that the cleaning and staining is performed in accordance with an organized navigation pattern along the individual deck boards.

Embodiments of the disclosed subject matter are directed to a method for traversal of a deck by an autonomous robot, the deck formed of spaced apart boards. The method comprises: the robot traversing at least one board by following a gap between the at least one board and another adjacent board; determining the gap, by the robot during the traversing to maintain the robot in alignment with respect to the first gap; and, the robot responding to the determining the gap by the robot moving along the at least one board to maintain alignment with respect to the gap during the traversal.

Optionally, the method is such that the determining the first gap and the robot moving in response to the determining the gap are continuous.

Optionally, the method is such that the alignment with respect to the gap includes the robot being positioned substantially centrally with respect to the gap.

Optionally, the method is such that the determining the gap is performed using a camera of the robot.

Optionally, the method is such that the determining the gap is performed using a gap sensor of the robot, the gap sensor including at least one light transmitter and reflected light receivers.

Optionally, the method is such that the determining the gap is performed using a camera of the robot and a gap sensor of the robot, the gap sensor including at least one light transmitter and reflected light receivers.

Optionally, the method is such that the robot traversing the at least one board includes the robot moving dirt and debris (e.g., material, particulates and the like): 1) inward with respect to the robot such that the dirt and debris is pushed into the gap, and, outward with respect to the robot, such that dirt is pushed over the boundary of the deck.

Optionally, the method is such that the robot traversing the at least one board includes the robot staining the deck.

Optionally, the method is such that the staining includes spraying stain from at least one nozzle.

Optionally, the method is such that the at least one nozzle includes a plurality of nozzles arranged adjacently with respect to each other, and extending widthwise along the robot.

Embodiments of the disclosed subject matter are directed to a method for a robot traversing a deck formed of spaced apart boards. The method comprises: detecting, by at least one first sensor, a first gap between two adjacent boards of the deck; aligning the robot with respect to the first gap; and, the robot traversing at least one board including the robot moving along the at least one board by following the first gap.

Optionally, the method is such that the following the first gap includes continuously detecting the first gap, such that the moving the robot along the at least one board includes continuously aligning the robot with respect to the first gap as the robot moves along the at least one board.

Optionally, the method is such that the aligning the robot with respect to the first gap includes the robot being positioned substantially centrally with respect to the first gap.

Optionally, the method is such that it additionally comprises: determining a bypass direction for the robot should an obstacle be detected.

Optionally, the method is such that the bypass direction is based on a map of an area previously traversed by the robot.

Optionally, the method is such that should the robot, by at least one second sensor, detect an obstacle while traversing the at least one board, the robot moves in the bypass direction around the obstacle.

Optionally, the method is such that the robot additionally moves to follow the obstacle along an edge of the obstacle and the robot counts subsequent gaps in deck boards which have been detected by the at least one first sensor, as having been passed during the movement following the obstacle along the edge of the obstacle.

Optionally, the method is such that the robot, from data provided by the at least first one sensor, determines whether the first gap has been reached, and, should the first gap be reached, the robot realigns with the gap.

Optionally, the method is such that after the gap is reacquired, the robot resumes traversing the at least one board by following the first gap in a position along the at least one board to be aligned with respect to the first gap.

Optionally, the method is such that the robot being aligned with respect to the first gap includes the robot being positioned substantially centrally with respect to the first gap.

Optionally, the method is such that should at least one of a cliff or wall be detected by at least one third sensor of the robot, the robot performs at least one of: stopping, or, turning to move toward a subsequent gap.

Optionally, the method is such that after the robot turns to move toward a subsequent gap, the robot moves to detect the subsequent gap.

Optionally, the method is such that the robot moves toward a subsequent gap including the robot moving past the subsequent gap, and turning with respect to the subsequent gap, to acquire the subsequent gap, as detected by the at least one first sensor.

Optionally, the method is such that the robot aligns with respect to the subsequent gap; and, the robot traverses at least one board including the robot moving along the at least one board by following the subsequent gap.

Optionally, the method is such that the robot aligning with respect to the subsequent gap includes the robot being positioned substantially centrally with respect to the subsequent gap.

Optionally, the method is such that the at least one first sensor includes at least one of a camera or a gap sensor, which detects gaps by receiving light reflected from the spaced apart boards of the deck, or combinations of the camera and the gap sensor.

Optionally, the method is such that the at least one second sensor includes at least one of a camera, a bumper sensor or a combination of the camera and the bumper sensor.

Optionally, the method is such that the at least one third sensor includes one or more of a camera, a cliff sensor, a boundary sensor, or combinations thereof.

Optionally, the method is such that during the traversing of the at least one board, the robot is performing at least one of staining, coating, or cleaning.

Optionally, the method is such that the staining, coating or cleaning includes at least one of a stain, pigment, paint, cleaning agent, cleaner, or a coating.

Embodiments of the disclosed subject matter are directed to a method for mapping a deck comprising a plurality of boards, each board spaced apart from each other to have gaps between them. The method comprises: moving a robot along at least one board, where the robot is aligned with respect to the gap between adjacent boards; determining the area traversed by the robot at a juncture, to where the robot has moved, creating a mapped area of the area traversed by the robot from the starting point of the traversal to the juncture; and, adding the mapped area to a map.

Optionally, the method is such that it additionally comprises: moving the robot along the at least one board, where the robot is aligned with respect to the gap, from the juncture; determining the area traversed by the robot at a subsequent juncture; creating a mapped area of the area traversed by the robot from the juncture to the subsequent juncture; and, adding the mapped area to the map by associating the boards traversed by the robot with respect to each other.

Optionally, the method is such that the juncture includes at least one of a predetermined distance, a predetermined time, a predetermined location on the deck, or a boundary of the deck.

Optionally, the method is such that the moving the robot along the at least one board includes moving the robot to follow an optimized pattern along the boards of the deck.

Optionally, the method is such that the moving the robot to follow the optimized pattern includes beginning the movement of the robot at the starting point of the traversal in accordance with the optimized pattern and ending the movement at the end point of the traversal of the optimized pattern.

Optionally, the method is such that the starting point and the end point are different locations.

Optionally, the method is such that the starting point and the end point are at least approximately the same location.

Optionally, the method is such that the map is created from camera images.

Optionally, the method is such that the map is created from one or more of the distance traveled, the heading, the offset, or at least one of the simultaneous localization and mapping (SLAM) algorithm, or the Visual SLAM (VSLAM) algorithm.

Optionally, the method is such that the robot being aligned with respect to the gap includes the robot being positioned substantially centrally with respect to the gap.

Embodiments of the disclosed subject matter are directed to a method for mapping a deck comprising a plurality of boards, each board spaced apart from each other to have gaps between them. The method comprises: moving a robot along at least one board, where the robot is aligned with respect to the gap between adjacent boards; continuously determining the area traversed by the robot while the robot moves along the at least one board; creating a mapped area of the area traversed by the robot from the continuously determined area being traversed; and, adding the mapped area to a map.

Optionally, the method is such that the adding the mapped area to the map is performed continuously corresponding to the area traversed by the robot being continuously determined.

Optionally, the method is such that the moving the robot along the at least one board includes moving the robot to follow an optimized pattern along the boards of the deck.

Optionally, the method is such that the moving the robot to follow the optimized pattern includes beginning the movement of the robot at the starting point of the traversal in accordance with the optimized pattern and ending the movement at the end point of the traversal of the optimized pattern.

Optionally, the method is such that the starting point and the end point are different locations.

Optionally, the method is such that the starting point and the end point are at least approximately the same location.

Optionally, the method is such that the robot being aligned with respect to the gap includes the robot being positioned substantially centrally with respect to the gap.

Embodiments of the disclosed subject matter are directed to a method for mapping a deck comprising a plurality of boards, each board spaced apart from each other to have gaps between them. The method comprises: moving a robot autonomously along a boundary of a deck beginning at a starting point along the boundary; mapping the boundary based on one or more images, until the robot has returned to a location at least proximate to the starting point; creating an area inside the mapped boundary; moving the robot along at least one board inside the area of the mapped boundary, where the robot is aligned with respect to the gap between adjacent boards; determining the area traversed by the robot while the robot moves along the at least one board; creating a mapped area of the area traversed by the robot from the determined area being traversed; and, adding the mapped area to a map.

Optionally, the method is such that the robot moving along the at least one board includes the robot moving along a plurality of boards in accordance with a pattern, and, determining the area traversed by the robot while the robot moves along the plurality of boards in accordance with the pattern; creating a mapped area of the area traversed by the robot from the determined area being traversed in accordance with the pattern; and, adding the mapped area to the map.

Optionally, the method is such that the robot aligned to with respect to a gap between adjacent boards includes the robot being positioned substantially centrally with respect to the gap.

Optionally, the method is such that it additionally comprises: updating the map continuously while the robot is moving in accordance with the pattern.

Optionally, the method is such that the pattern includes an optimized pattern for traversing the mapped area inside of the boundary

Optionally, the method is such that the moving the robot to follow the pattern includes beginning the movement of the robot at the starting point and terminating movement of the robot an end point.

Embodiments of the disclosed subject matter are directed to a sensor for detecting gaps between spaced apart boards in a deck. The sensor comprises: at least one transmitter for transmitting energy in waves; a first receiver for receiving reflected energy waves transmitted from the at least one transmitter, the first receiver including a first reception range; a second receiver for receiving reflected energy waves transmitted from the at least one transmitter, the second receiver including a second reception range; and, the first reception range and the second reception range adjacent to each other; wherein based on the amount of reflected energy received in each of the first receiver and the second receiver, a gap displacement is detected between two spaced apart boards in a deck.

Optionally, the sensor is such that the adjacent first and second ranges include an overlapping portion.

Optionally, the sensor is such that the transmitter is intermediate to the first and second receivers.

Optionally, the sensor is such that the first and second receivers are coplanar with the at least one transmitter, and are equidistant from the at least one transmitter on each side of the at least one transmitter.

Optionally, the sensor is such that the transmitted energy in waves from the at least one transmitter include infrared (IR) light, and the first receiver and the second receiver are configured to receive the energy waves including IR light.

Optionally, the sensor is such that the at least one transmitter includes one transmitter.

Optionally, the sensor is such that the at least one transmitter includes a plurality of transmitters.

Optionally, the sensor is such that the gap is determined to be centered when there the light energy received by the first receiver and the second receiver is at least approximately equal.

Optionally, the sensor is such that the approximately equal is defined within a predetermined threshold.

Optionally, the sensor is such that the light energy received by the first receiver and the second received is in amounts corresponding to ratios.

Embodiments of the disclosed subject matter are directed to a capsule for removably attaching to a payload of a robot. The capsule comprises: a reservoir; at least one nozzle; a conduit in communication with the reservoir and the nozzle; and, an air distribution system. The air distribution system comprises: a first channel in communication with the reservoir, such that when pressurized air is received from a pressurized air source, fluid flows from the reservoir to the at least one nozzle, and, a second channel in communication with the at least one nozzle, such that when pressurized air is received from a pressurized air source, the pressurized air atomizes the fluid, creating a spray.

Optionally, the capsule is such that the at least one nozzle includes one or more openings to the ambient environment through which the fluid flows prior to atomization.

Optionally, the capsule is such that it additionally comprises a chamber for holding the received fluid prior to the fluid exiting the at least one nozzle.

Optionally, the capsule is such that the reservoir is prefilled with fluid.

Optionally, the capsule is such that the fluid includes one or more of stain, paint, cleaning liquid, coating, and, water.

Optionally, the capsule is such that the at least one nozzle includes a plurality of nozzles spaced apart from each other to extend widthwise with respect to the robot.

Optionally, the capsule is such that the reservoir is configured to be filled with fluid from a source external to the robot.

Optionally, the capsule is such that the source external to the robot includes a base station.

Embodiments of the disclosed subject matter are directed to a capsule for removably attaching to a payload of a robot. The capsule comprises: a reservoir; at least one nozzle; a conduit in communication with the reservoir and the nozzle; a first channel in communication with the reservoir, such that when the reservoir has pressure applied thereto, fluid flows from the reservoir to the at least one nozzle, and, an air channel in communication with the at least one nozzle, such that when pressurized air is received from a pressurized air source, the pressurized air atomizes the fluid, creating a spray.

Optionally, the capsule is such that the portion of the capsule including the reservoir is of a flexible material which moves inward when a force is applied thereto, causing the fluid to flow to the at least one nozzle.

Embodiments of the disclosed subject matter are directed to a system for discharging spray from a robot. The system comprises: a capsule for removably attaching to a payload of a robot. The capsule comprises: a reservoir for holding fluid; at least one nozzle, through which fluid is discharged from the capsule; a conduit in communication with the reservoir and the nozzle; and, an air distribution system. The air distribution system comprises: a first channel in communication with the reservoir, such that when pressurized air is received from a pressurized air source, fluid flows from the reservoir to the at least one nozzle, and, a second channel in communication with the at least one nozzle, such that when pressurized air is received from a pressurized air source, the pressurized air atomizes the fluid, creating a spray; and, a pressurized air source in communication with each of the first channel and the second channel.

Optionally, the system is such that the pressurized air source includes a first air source for the first channel, and a second air source for the second channel.

Optionally, the system is such that the first air source includes a pump.

Optionally, the system is such that the pump is controlled by a processor.

Optionally, the system is such that the second air source includes a turbine.

Optionally, the system is such that the turbine is controlled by a processor.

Optionally, the system is such that the at least one nozzle includes one or more openings to the ambient environment through which the fluid flows prior to atomization.

Optionally, the system is such that it additionally comprises a chamber for holding the received fluid prior to the fluid exiting the at least one nozzle.

Optionally, the system is such that the reservoir is prefilled with fluid.

Optionally, the system is such that the fluid includes one or more of stain, paint, cleaning liquid, coating, or, water.

Optionally, the system is such that it additionally comprises: a valve in communication with the conduit for controlling fluid flow between the reservoir and the nozzle.

Optionally, the system is such that the valve is controlled by a processor.

Optionally, the system is such that the first channel includes a pressure sensor in communication with the processor controlling the pump.

Embodiments of the disclosed subject matter are directed to a cleaning system for a robot. The cleaning system comprises: a first brush for rotating about a vertically oriented axis in a first direction; a second brush oppositely disposed from a the first brush, the second brush for rotating about a vertically oriented axis in a second direction, opposite the first direction; and, a third brush for rotating about a horizontal axis intermediate the first brush and the second brush; wherein, the first brush and the second brush rotate to move material inward, with respect to the robot, and into proximity with the third brush, and, the third brush rotates to move the material outward with respect to the robot.

Optionally, the cleaning system is such that the first brush rotates counterclockwise, and the second brush rotates clockwise.

Optionally, the cleaning system is such that the first brush, the third brush, and, the second lateral brush extend substantially the width of the robot.

Optionally, the cleaning system is such that the third brush includes at least two brushes, each of the brushes rotating about a horizontal axis, and are angled with respect to the robot, from an origin within the robot, such that the brushes extend outward from the origin.

Optionally, the cleaning system is such that 91. The cleaning system of claim 90, wherein the brushes are oriented with respect to each other and the origin to form a V shape.

Embodiments of the disclosed subject matter are directed to a cleaning system for a robot. The cleaning system comprises: a first brush rotatable about a horizontal axis with respect to the robot; and, a second brush rotatable about a horizontal axis with respect to the robot; the first brush and the second brush angled with respect to the robot, from an origin within the robot, such that the first brush and the second brush extend outward from the origin.

Optionally, the cleaning system is such that the first brush and the second brush rotate in a direction to move material outward with respect to the robot.

Optionally, the cleaning system is such that the first brush and the second brush are oriented with respect to each other and the origin to form a V shape.

Optionally, the cleaning system is such that the span of the first brush and the second brush extends substantially the width of the robot.

Embodiments of the disclosed subject matter are also directed to a cleaning system for a robot. The robot comprises: a first brush rotatable about a horizontal axis with respect to the robot, and rotatable in a direction to move material outward with respect to the robot; and, a second brush rotatable about a vertical axis with respect to the robot, and, rotatable to move material into proximity with the first brush.

Optionally, the cleaning system is such that the first brush and the second brush extend substantially the width of the robot.

Embodiments of the disclosed subject matter are directed to a stain composition, for example, for wood deck boards. The composition comprises: a material including oil in water emulsion having a mean oil droplet size of approximately 100-300 nm, solid concentration of approximately 20-40 wt %, viscosity of approximately 100-1000 cP and a surface tension of approximately. 30-50 mN/m.

Optionally, the stain composition is such that the material additionally comprises: colorants and/or pigments.

Optionally, the stain composition is usable as the prefilled fluid in the capsules detailed above.

Unless otherwise defined herein, all technical and/or scientific terms used herein have the same meaning as commonly understood by one of ordinary skill in the art to which the disclosed subject matter pertains. Although methods and materials similar or equivalent to those described herein may be used in the practice or testing of embodiments of the disclosed subject matter, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

Some embodiments of the present disclosed subject matter are herein described, by way of example only, with reference to the accompanying drawings, with specific reference to the drawings in detail, it is stressed that the particulars shown are by way of example and for purposes of illustrative discussion of embodiments of the disclosed subject matter. In this regard, the description taken with the drawings makes apparent to those skilled in the art how embodiments of the disclosed subject matter may be practiced.

Attention is now directed to the drawings, where like reference numerals or characters indicate corresponding or like components. In the drawings:

FIG. 1 is a front perspective view of an autonomous robot of the disclosed subject matter;

FIG. 2A is a bottom view of the robot of FIG. 1;

FIGS. 2B-1 to 2B-4 are top views of the robot showing various brush arrangements;

FIG. 3 is a transverse of widthwise cross sectional view of the robot looking forward;

FIG. 4 is a longitudinal or lengthwise cross sectional view of the robot;

FIG. 5A is a top perspective view of the payload of the robot;

FIG. 5B is a cross section of the perspective view of FIG. 5A;

FIG. 5C is a detail view of the payload;

FIG. 5D is a bottom view of two sprayers;

FIG. 5E-1 is a bottom view of the gap sensor;

FIG. 5E-2 is a side view of the gap sensor of FIG. 5E-1;

FIGS. 5E-3 and 5E-4 are side views of the gap sensor showing example operations;

FIG. 6A is a rear perspective view of the robot having a modular capsule;

FIG. 6B-1 is a perspective view of the modular capsule of FIG. 6A;

FIG. 6B-2 is a bottom view of the sprayer of the capsule of FIG. 6B-1;

FIG. 7 is a bottom perspective view of the robot in operating with the modular capsule of FIGS. 6A and 6B-1;

FIG. 8A is a block diagram of a low level controller of the robot;

FIG. 8B is a block diagram of a high level controller of the robot;

FIG. 9 is a flow diagram of an example process for obtaining deck board parameters, as performed by the robot;

FIG. 10 is a flow diagram of an example process for traversing a board, as performed by the robot;

FIGS. 11A and 11B are a flow diagram of an example process for moving from deck board to deck board, as performed by the robot;

FIG. 12 is a flow diagram of an example process for deck mapping, as performed by the robot;

FIGS. 13A-13J are diagrams of a robot traversing boards and moving from board to board, in accordance with the processes of FIGS. 10, 11A and 11B; and,

FIG. 14 is an example scanning or exploration pattern for a deck of spaced apart boards.

### DETAILED DESCRIPTION OF THE DRAWINGS

Before explaining at least one embodiment of the disclosed subject matter in detail, it is to be understood that the disclosed subject matter is not necessarily limited in its application to the details of construction and the arrangement of the components and/or methods set forth in the following description and/or illustrated in the drawings. The disclosed subject matter is capable of other embodiments or of being practiced or carried out in various ways.

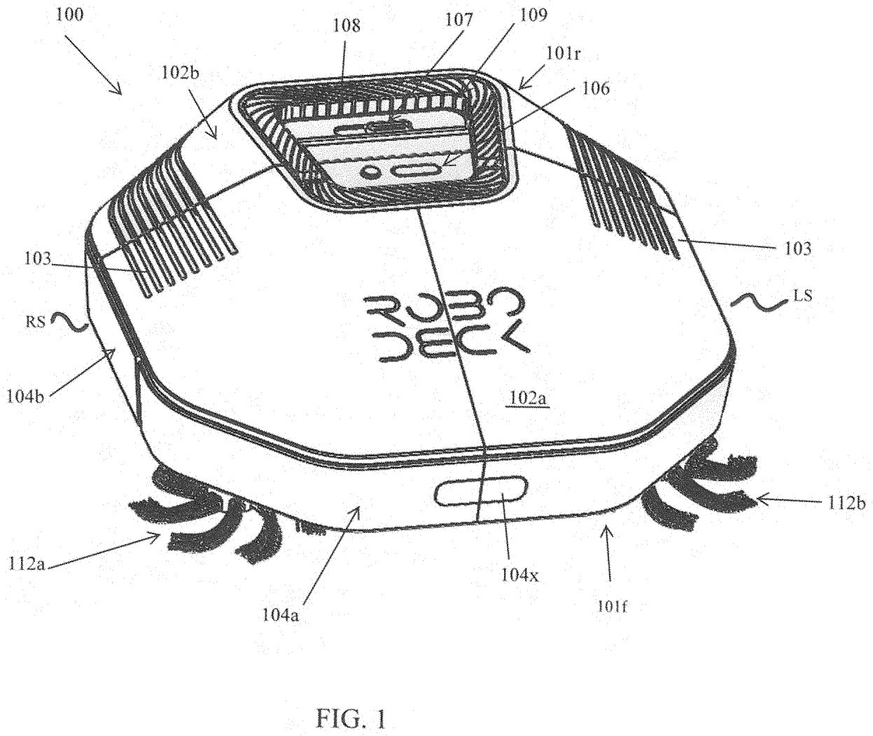

Throughout this document, references to directions, such as front, rear, upward, downward, upper, lower, up, down, top, bottom, right, left, and the like, are made. These directional references are to typical orientations for the robot 100, shown in FIGS. 1-7 and/or components thereof. They are exemplary only, and not limiting in any way, as they are for description and explanation purposes.

FIG. 1 shows the robot 100 in a front perspective view. The robot 100 includes a front end 101f and a rear end 101r. The robot 100 has a payload 101, for example, for cleaning, staining, and optionally sanding a wood deck. The payload 101 is covered by a cover 102, for example, formed of two panels, a front panel 102a and a rear panel 102b. The front cover panel 102a, typically include vents 103, allowing for the flow of air to and from the ambient environment into the payload 101 of the robot 100.

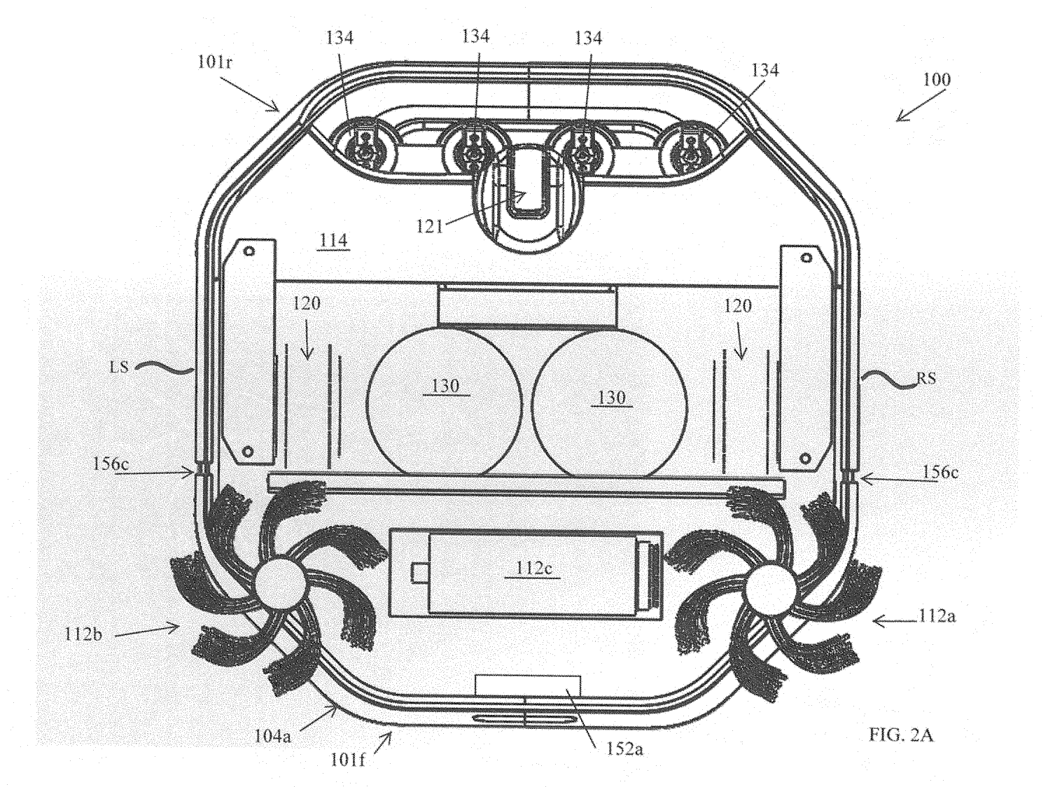

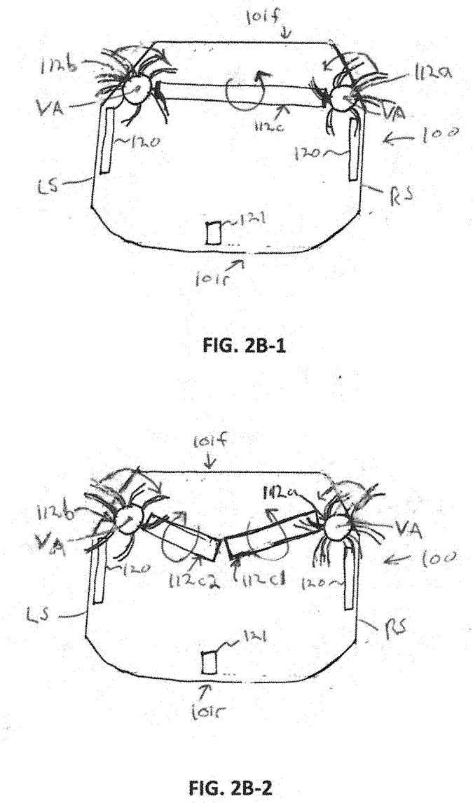

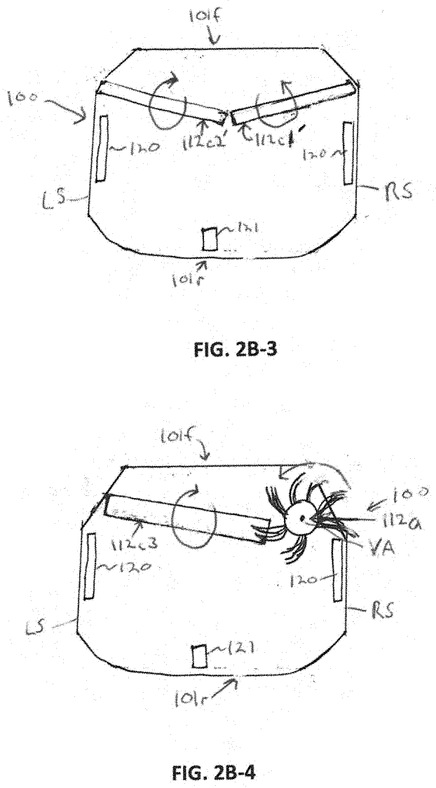

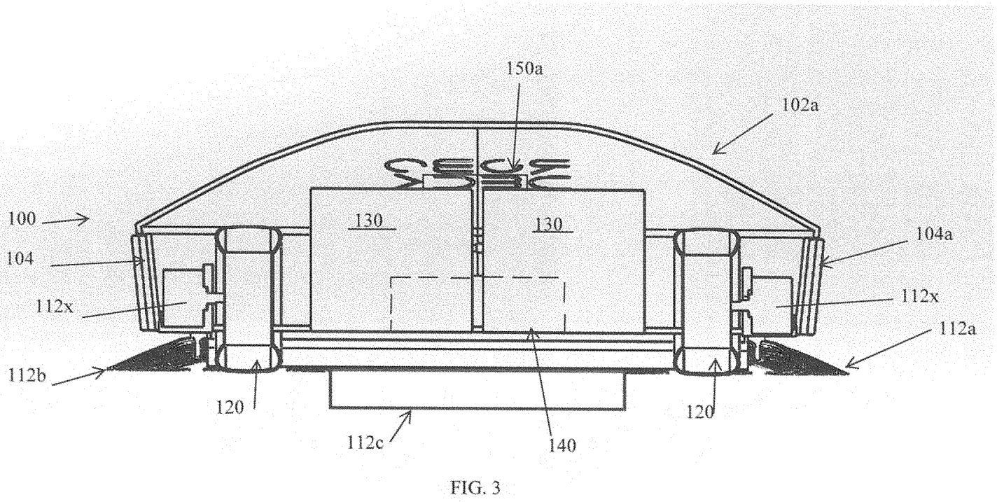

Front 104a and rear 104b, skirts, extend along the lower side of the robot 100, also to cover the payload 101. The front skirt 104a is mounted to the chassis 114 (FIGS. 2A and 3) of the robot 100 in a spring-like manner, to serve as a bumper, with bumper sensors 156d mounted between the skirt 104a and the chassis 114 at the front 101f and laterally, at the left side (LS) and the right side (RS) (the left side and right side as oriented on the robot 100 as per FIG. 1), such that if the sensor 156d is depressed beyond a certain point, for example, upon contact with an object, will cause the robot 100 to stop moving, as detailed further below. The rear skirt 104b is attached to the rear panel 102b, so as to be stationary.

Intermediate to the cover panels 102a, 102b, along the upper side of the robot 100, is a user interface 106, with various buttons, Light Emitting Diodes (LEDs), and ports for receiving remote control and programming via wireless connections, such as WIFI® (via a WIFI® antenna within the payload 101 but not shown), Bluetooth™, and the like, such as from smart phones and other networked devices, as well as remote controllers, for operating the robot 100.

There is also a button 107, that when depressed, opens the rear cover panel, 102b, allowing access to the payload 101, to reservoirs 132 or tank 200 (FIGS. 6A, 6B-1 and 6B-2), for refilling with stain, fluid and the like, or replacing a modular tank or capsule 200 (FIGS. 6A, 6B-1 and 6B-2), for example, with a new tank or capsule, either empty of prefilled with stain, coating, cleaning fluid, and the like. A handle 108, with laterally extending stubs 108a, may also be pulled from the side wall 109, with the stubs 108x moving forward in tracks 109x in the sidewall, to stop surfaces 109y, where the handle 108 is and pivoted, allowing the handle 108 to be moved upward, so that the robot 100 may be carried. The handle 108 can be stowed in the sidewall 109 by performing the aforementioned procedure in reverse.

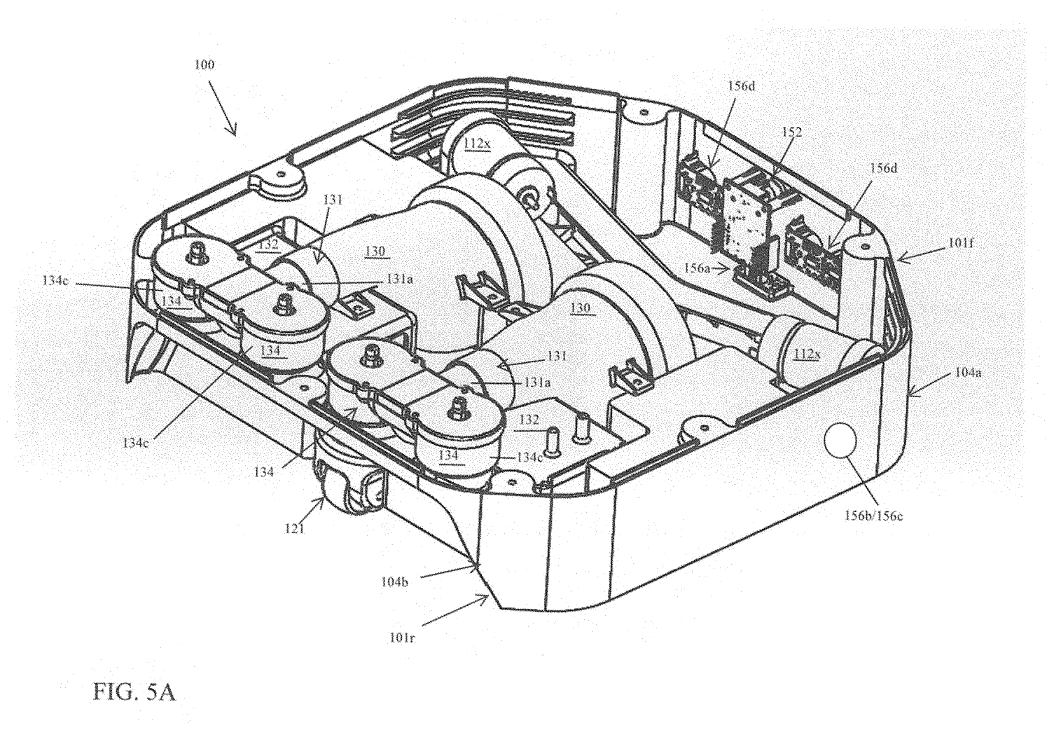

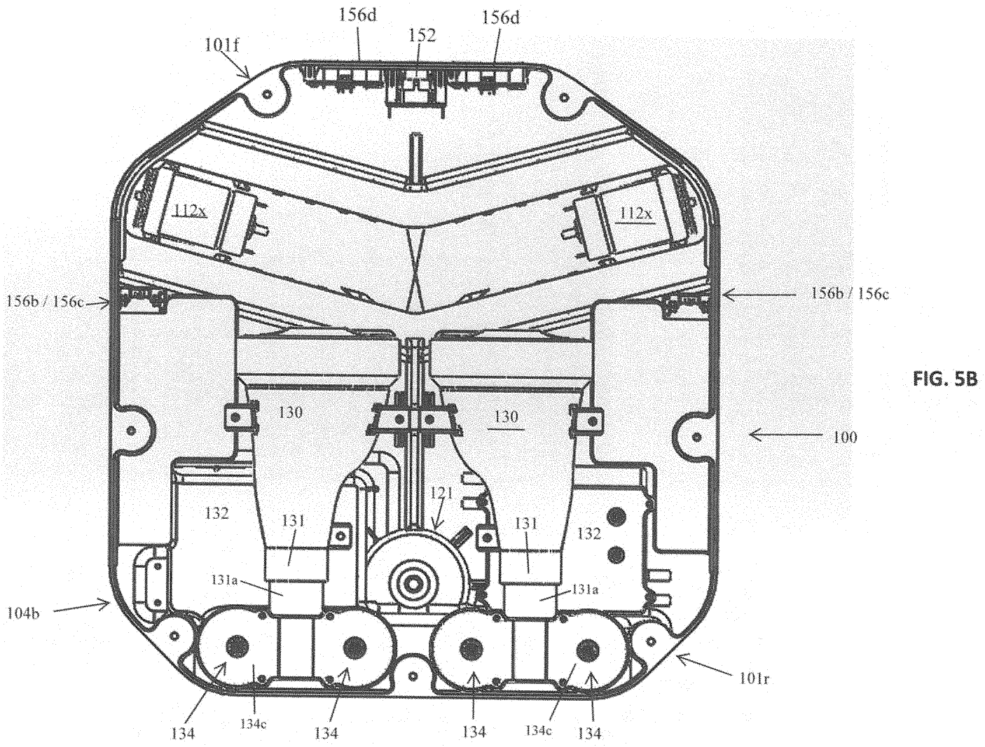

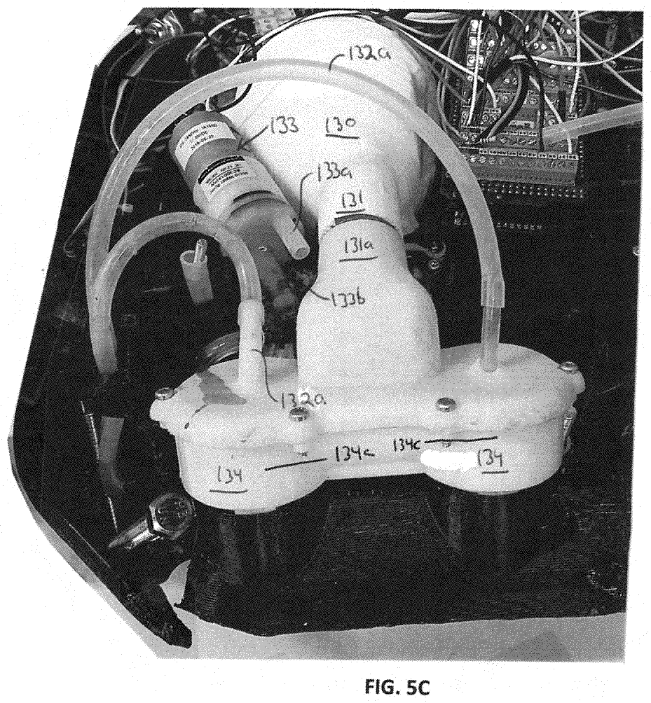

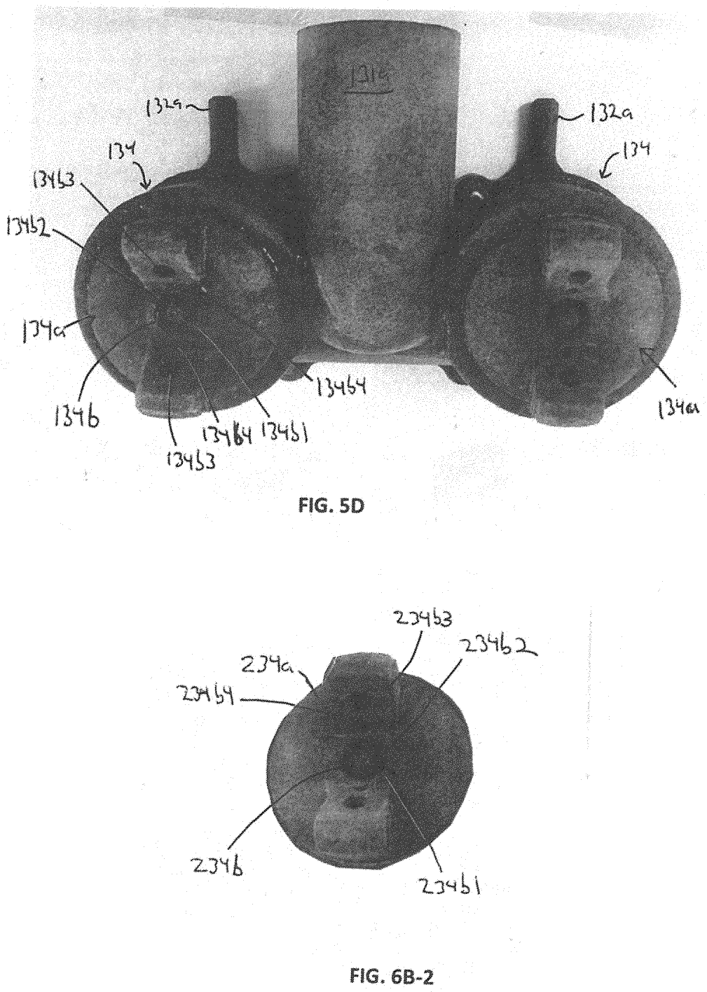

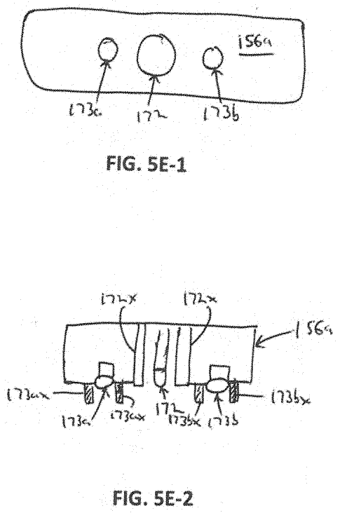

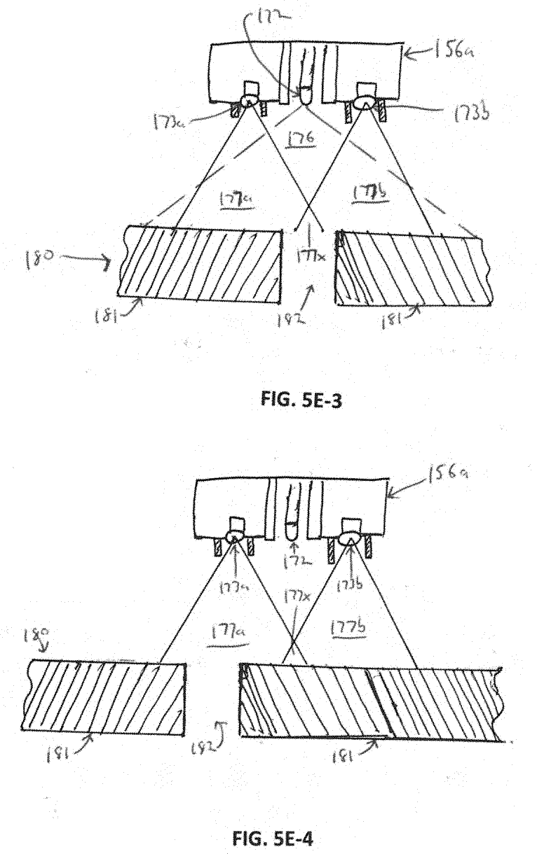

The front skirt 104a includes an opening 104x, through which a camera 152 obtains images, and sensors 156 (FIGS. 5A and 5B) send and detect signals. Alternately, the opening 104x may also be placed on the cover panel 102a, instead of or in addition to the opening 104x in the front skirt 104a.

Brushes 112a, 112b, for example, rotary brushes or scrubbers, rotated by motors 112x (FIGS. 5A and 5B) (about vertical axes with respect to the robot 100), for cleaning debris from the deck surface, are positioned on the lateral sides of the robot 100, at the front end of the robot 100. As the robot 100 typically moves being led by the front end 101f, the brushes 112a, 112b clean the deck (e.g., deck boards) of debris, prior to applying of stain and/or paint, to the deck boards. A rotor or rolling brush 112 (FIG. 2A), rotating on a horizontal axis with respect to the robot 100, is between the scrubbers 112a, 112b. The scrubbers 112a, 112b, for example, overlap the span of the rotor brush 112, and the span of the scrubbers 112a, 112b and the rotor brush 112c, extend widthwise with respect to the robot 100, so as to, for example, extend substantially the width of the robot 100, or extend beyond the width of the robot 100.

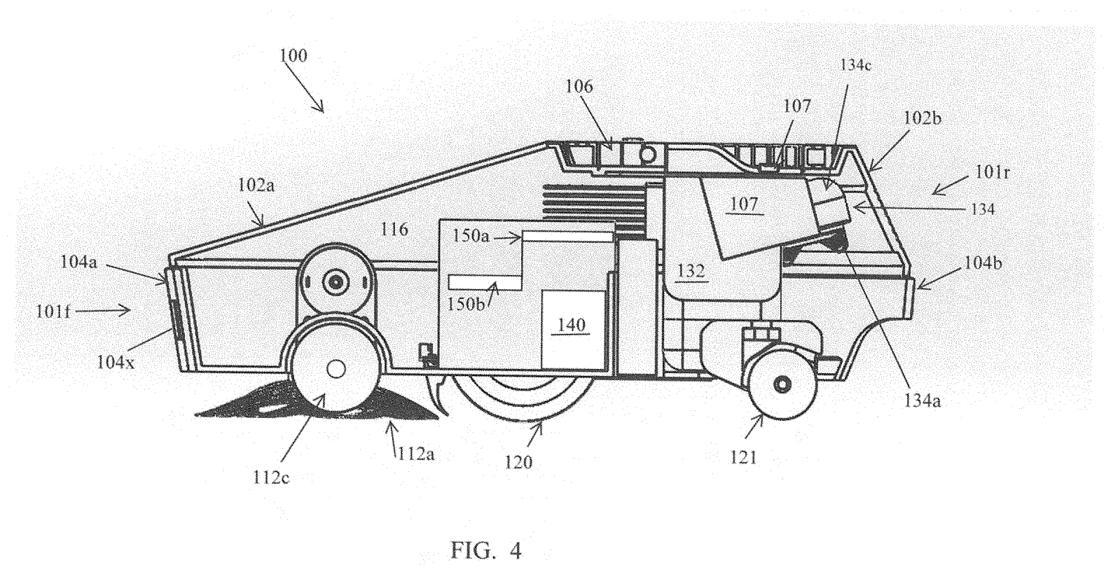

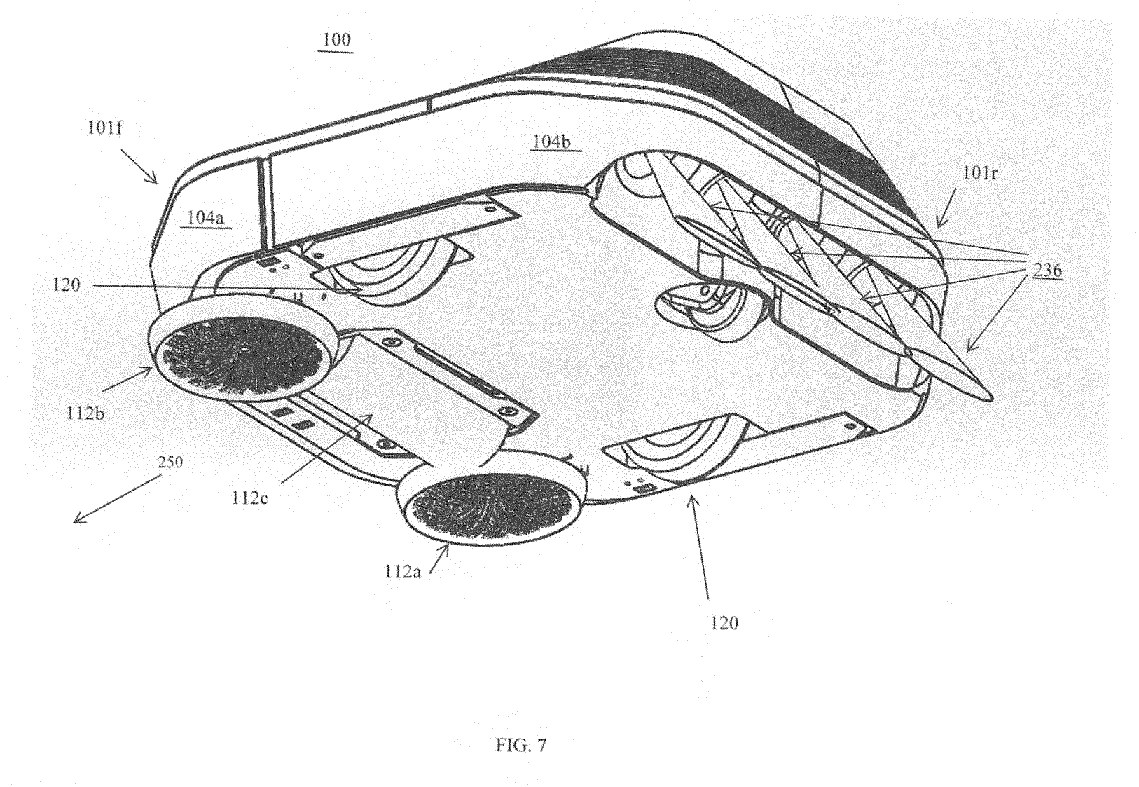

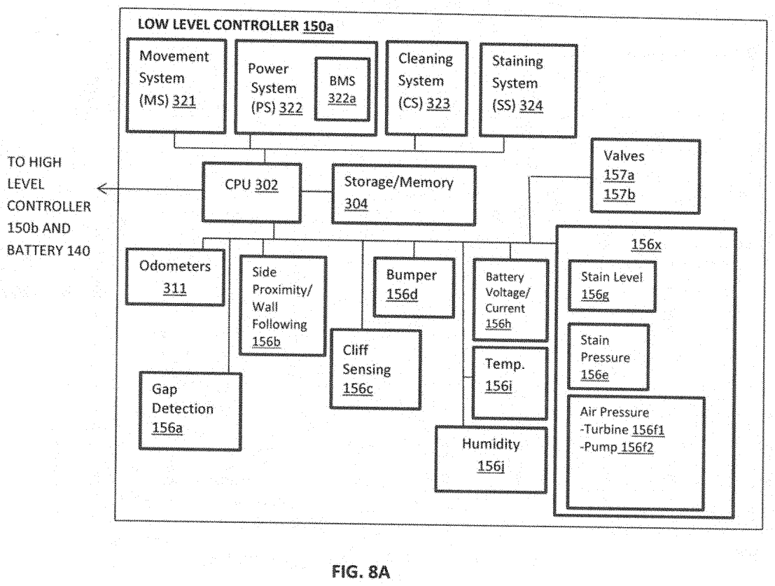

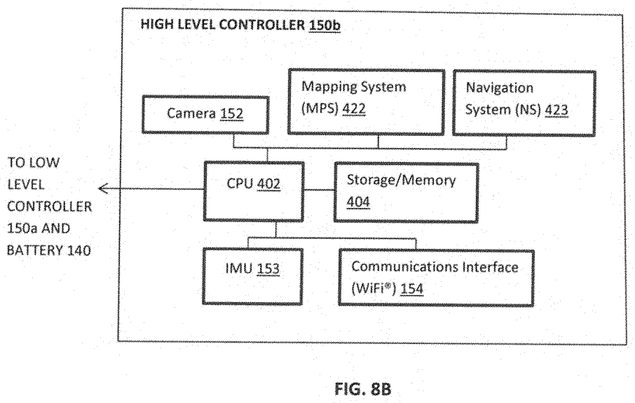

Turning also to FIGS. 2A, 3 and 4, the robot 100 is shown from the bottom or lower side (FIG. 2A), and in cross section, looking toward the front end 101f of the robot 100 (FIG. 3), and longitudinally, in FIG. 4. The robot 100 includes a chassis 114, which supports the payload 101. A rotor brush 112c, controlled by a motor 116, is, for example, a rolling brush, which extends between the brushes (scrubbers) 112a, 112b, for example, centrally, so as to provide for cleaning of debris along the width of the robot 100, such that a clean area is prepared prior to staining and/or painting. The lateral brushes 112a, 112b and rotor brush 112c, coupled with their controlling mechanism in the lower level controller 150a, form the cleaning system (CS) 323 (FIG. 8A) for the robot 100 payload 101. The lateral brushes 112a, 112b and central rotor brush 112c are connected to a lifting mechanism, which is also part of the cleaning system (not shown), for moving the lateral brushes 112a, 112b and central rotor brush 112c vertically, to adjust their height with respect to the deck (ground) surface, over which the robot 100 is traveling.

Turning also to FIG. 2B-1, the robot 100 is shown in a brush arrangement, such that the brushes 112a, 112b work in conjunction with the central rotor brush 112c, such that dirt and debris is brought inward by the brushes 112a, 112b, into the range of the rotor brush 112c, which pushes the dirt and debris outward, into gaps and over boundaries of the deck. The brushes (scrubbers) 112a, 112b rotate about vertical axes (VA), for example, brush 112a rotating counterclockwise, and brush 112b rotating clockwise. The rotor brush 112c rotates about a horizontal axis, and for example, counterclockwise with respect to the right side (RS) of the robot, so dirt and debris which accumulates in the space between the brushes 112a, 112b and the rotor brush 112c is pushed forward towards the gaps and the boundaries of the deck boards. For example, the brushes 112a, 112b overlap the central rotor brush 112c, and the brushes 112a, 112b, 112c span at least the width or approximately the width (between the left side (LS) and the right side (RS) of the robot 100) of the robot 100.

Alternately, as shown in FIG. 2B-2, for the robot 100, the central rotor brush 112c (from FIG. 2B-1) is formed of two brushes 112c1 and 112c2, oriented at an angle with respect to each other, so as to be in a V shape. These brushes 112c1, 112c2 work with the scrubbers 112a, 112b in the same manner as the brush arrangement shown in FIG. 2B-1, with brush 112c1 rotating counterclockwise with respect to the right side (RS) of the robot 100, and brush 112c2 rotating clockwise with respect to the left side (LS) of the robot. For example, the brushes 112a, 112b overlap the central rotor brushes 112c1, 112c2, and the brushes 112a, 112b, 112c1 and 112c2 span at least the width or approximately the width (between the left side (LS) and the right side (RS) of the robot 100) of the robot 100.

Alternately, as shown in FIG. 2B-3, for the robot 100, there is a central rotor brush 112c (from FIG. 2B-1), which is formed of two brushes 112c1′ and 112c2′, oriented at an angle with respect to each other, so as to be in a V shape. These brushes 112c1′, 112c2′ rotate (for example brush 112c1′ rotates counterclockwise with respect to the right side (RS) of the robot 100, and brush 112c2′ rotates clockwise with respect to the left side (LS) of the robot 100 to push dirt and debris forward towards the gaps and the boundaries of the deck boards. For example, rotor brushes 112c1′, 112c2′ typically overlap at the middle of the robot 100, and the brushes 112c1′ and 112c2′ span at least the width or approximately the width (between the left side (LS) and the right side (RS) of the robot 100) of the robot 100.

Alternately, as shown in FIG. 2B-4, for the robot 100, one scrubber 112a is teamed with a rotor brush 112c3, the rotor brush angles inward, so as to be overlapped by the scrubber 112a. The scrubber 112a, for example, rotates counterclockwise, to being dirt and debris into the range of the rotor brush 112c3, which rotates clockwise with respect to the left side (LS) of the robot 100, to push dirt and debris forward towards the gaps and the boundaries of the deck boards. For example, the brushes 112a, 112c3 span at least the width or approximately the width (between the left side (LS) and the right side (RS) of the robot 100) of the robot 100.

Drive wheels 120 are positioned laterally, on the left and right sides of the on the robot 100, and combined with the castor wheel 121, provide the wheels for the movement system (MS) 321 of the robot 100. The drive wheels 120 connect to motors 124, which rotate the drive wheels 120, such that they can operate to move and/or steer the robot 100 in straight lines, or perform turns, or combinations thereof, based on the individual motors 124 operating on each respective drive wheel 120. The drive wheels 120 may also be suspended using a spring loaded axle. Odometers 311 (FIG. 8A) connect to each drive wheel 120, to obtain the velocity and total distance (forward and rearward) traveled by the robot 100. The castor wheel 121, is, for example, rearward of the drive wheels 120 (toward the rear end 101r of the robot 100), and is typically a non-powered or passive wheel, providing for stability of the movement system 321 and support of the robot 100 on surfaces. The drive wheels 120 and the castor wheel 121, coupled with their controlling mechanism in the controller 150a, form the movement system (MS) 321 (FIG. 8A) for the robot 100. The movement (MS) 321 system is, for example, coupled with a mapping system (MPS) 422 (FIG. 8B) and a navigation system (NS) 423 (FIG. 8B), for moving the robot 100 in a programmed pattern along the deck.

Turning also to FIGS. 5A, 5B, and 5C turbines or fans 130 provide force for pressurized air, in order to spray the stain, paint, coating, cleaning solution and the like (collectively referred to hereinafter as “stain”). The turbines 130 are in fluid communication, for example, via conduits 131, including a port portion 131a (FIG. 5C), which lead to sprayers 134 (or spraying heads). The turbines 130 provide pressurized air for atomizing the fluid, i.e., the stain (liquid), from the reservoir 132, via the sprayer 134, upon its discharge from the robot 100 as a spray. The turbine 130 creates air flows, for example, of approximately, 3.5 liters/second at a pressure of approximately 6 KiloPascals (KPA), to atomize the stain (liquid). This pathway for the pressurized air is an air channel, which is, for example, part of an air distribution system for the staining system 423.

The stain is, for example, any commercially available liquid stain, such as Intergrain® Decking Oil, from Intergrain Timber Finishes of Australia. The stain may also be a liquid stain, of material in which an oil in water emulsion has a mean oil droplet size of 100-300 nm, solid concentration of 20-40 wt %, viscosity of 100-1000 cP and a surface tension of 30-50 mN/m. This composition may be tinted, colored, pigmented, or the like, as necessary depending on the deck board coloration, environmental conditions of the geographic location of the deck, and the like. The aforementioned stains may also be used to refill the reservoirs 132/232, or in the case of the capsule 200, be prefilled in a new capsule 200.

The stain is held in reservoirs 132, prior to its being pumped into the sprayers 134, by one or more pumps 133 (FIG. 5C). The pump 133 provides pressurized air (from an air intake 133a via a tube 133b, as shown in FIG. 5C) to the reservoir 132, which moves the fluid, e.g., stain, in the reservoir 132, through a conduit 132a, such that the stain flows from the reservoir 132 to the respective sprayer(s) 134, for example, into a receiving chamber 134c. The pump 133 pressure, for example, is approximately 40-100 milliBars. This pathway for the pressurized air from the pump forms an air channel of the air distribution system.

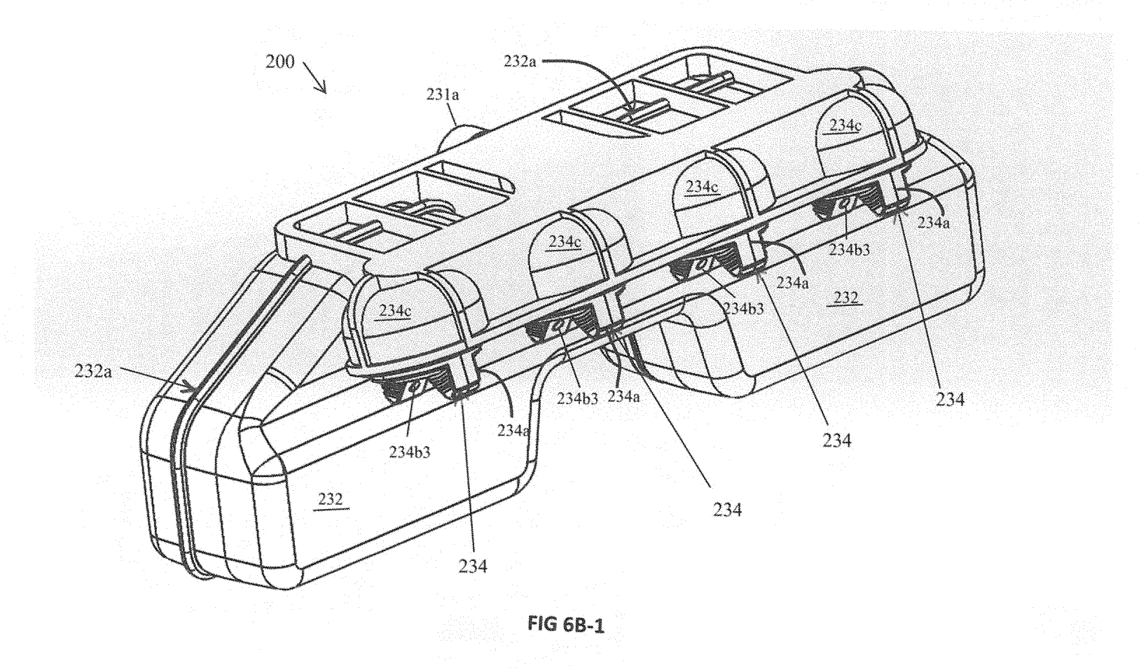

The sprayers 134 are, for example, positioned at the rear end 101r of the robot 100, so as to be operable after the brushes 112a-112c have cleaned the deck of debris. The sprayers 134 are aligned coplanar or substantially coplanar, for example, in pairs (FIGS. 5C and 5D) to span the width of the robot 100. As shown in FIG. 5D, each sprayer 134 includes a nozzle 134a, through which the stain is sprayed. The nozzle 134a includes typically one aperture (liquid aperture) 134b, although plural apertures are suitable. Within the aperture 134 is a bump 134b1, to which the liquid, e.g., stain, moves along, prior to discharge as spray. The bump 134b1 is surrounded by an air chamber 134b2, which receives air from the port portion 131a of the conduit 131, over its own air line (not shown). This air is pressurized at pressures sufficient to atomize the stain (liquid) on the bump 134b1, such that a spray of the stain is discharged. Air apertures 134b3, 134b4, for example, elevated from the surface of the nozzle 134a, receive air from the port portion 131a of the conduit 131, over its own air line (not shown, although the air line may have common pathways with the air line which feeds the air chamber 134b2). The air flowing through the air apertures 134b3, 134b4 flattens the spray, so that it is discharges as an oval cone 236, as shown, for example in FIG. 7.

Within the sprayers 134 are stain pressure sensors 156e, which measure the pressure at which the stain is being sprayed. Air pressure sensors 156f1 in the conduit 131 of the turbine 130, and air pressure sensors 156f2 in the pump 133 or in the tube 133b to the reservoir 132, detect the air pressures and report these pressures to the CPU 302, for controlling the staining system 324. Valves 157a (shown in FIG. 8A) control fluid flow through the conduits 132a, to control the amount of fluid flowing from the reservoirs 132 to the sprayers 134. These valves are controlled by the CPU 302 for the staining system 324. The sprayers 134 may also include internal valves 157b (FIG. 8A), which control stain flow and the amount (volume) thereof leaving the sprayer 134. The valves 157a, 157b also serve to prevent stain from being sprayed when the robot 100 is turning in place.

Within the reservoirs 132 are sensors 156g, which determine the amount of stain left in the reservoir 132. The sensors 156e, 156f1, 156f2, 156g send their information (e.g., signals) to the low level controller 150a. The turbines 130, conduits 131, reservoirs 132 and sprayers 134, pumps 133, sensors 156e, 156f1, 156f2, 156g, valves 157a, 157b, form the staining system (SS) 324 (FIG. 8A) for the robot 100, which is coupled with the low level controller 150a. The temperature sensor 156i and humidity sensor 156j may also be part of the staining system 324, as they sense ambient conditions, which may affect the spraying of stain, hence, controlling the amount of stain released from the reservoirs and the pressures at which it is sprayed.

A power source 140, such as a battery, is in communication, e.g., electronic communication, with the controllers 150a, 150b as well as the motors for the brushes 112x, 116, drive wheel motors 124, and, spray turbines 130, to provide power thereto. A battery voltage sensor 156h connects to the battery 140 and sends signals as to the battery voltage to the low level controller 150a. The battery 140, with its electrical connections to the components of the payload 101, form the power system (PS) 322 (FIG. 8A) for the robot 100. Electrical connections to the battery are made via drivers that control the power from the battery 140 to each motor 112x, 116, 124. There are also sensors 156h that sense discharge and charge currents of the battery 140. The battery 140 is managed by a battery management system (BMS) 322a, for example a processor which controls connections and configurations of the battery cells of the battery 140. The BMS 322a, for example, communicates with the low level controller 150a.

Attention is also directed to FIGS. 5A and 5B, which show the payload 101 of the robot 100. The payload 101 shows the motors 112x for rotating the brushes 112a, 112b, as well as the power source 140, e.g., the battery.

There are, for example, two controllers 150a, 150b, the low level controller 150a, as mentioned above, and a high level controller 150b, in electronic and/or data communication with each other, and both supported by printed circuit boards, and including processors and memory. The low level controller 150a controls the Movement System (MS) 321, the Power System (PS) 322 (including the BMS 322a), the Cleaning System (CS) 323, and, the staining system (SS) 324, and the user interface 106 for the robot 100, and shown in detail in FIG. 8A. The high level controller 150b controls the camera 152, a mapping system (MPS) 422, and a navigation system (NS) 423, and WIFI® communication 154, for the robot 100, and is shown in detail in FIG. 8B.

The front skirt 104a of the robot 100 supports a camera 152 or other imaging device, aligned with the opening 104x (FIG. 1). The camera 152 is in wired and/or wireless communication with the high level controller 150b. The camera 152 captures images, both video and still and typically includes image processing capabilities, such as distortion correction (e.g., dewarping, normalization, line detection, and the like. The camera is typically a standard camera, but may also be a Red, Green, Blue (RGB) camera, an Infra-Red (IR) camera, and a near-IR camera. There is also an inertial measurement unit (IMU) 153, including a magnetometer, a gyro meter, for measuring angular velocities, and an accelerometer, and a communications interface 154, for example, for wireless communications (e.g., WiFi®) with computers, including smart phones, remote controllers and the like, from which control signals are sent, and to which robot operational signals are sent. Each CPU 302 (FIG. 8A), 402 (FIG. 8B) may be programmed and data collected from the robot 100 via the aforementioned computers, smart phones and the like. The IMU 153 and communications interface 154 are in wired and/or wireless communication with the high level controller 150b.

Sensors 156a, 156b, 156c, 156d are also positioned along and supported by the front skirt 104. The sensors, for example, include deck board detection or gap (between the deck boards) sensing 156a, proximity/wall following 156b, cliff sensing 156c, and bumper 156d. These sensors 156a, 156b, 156c, 156d are in wired and/or wireless communication with the low level controller 150a (and the CPU 302).

FIGS. 5E-1 and 5E-2 show the gap sensor 156a, positioned on the lower side of the robot 100, as shown in FIG. 5A. The gap sensor 156a includes a transmitter 172 and receivers 173a, 173b on the sides of the transmitter 172. For example, the transmitter 172 and receivers 173a, 173b are coplanar, with the receivers 173a, 173b equidistant from the transmitter 172. The transmitter 172 and receivers 173a, 173b are light (energy wave) transmitters and light (energy wave) receivers, and, for example, infra-red (IR) light (energy wave) transmitters and IR (reflected light (energy wave)) receivers. While a single transmitter 172 is shown, multiple transmitters are also permissible, as are multiple receivers 173a, 173b on the sides of the transmitter.

Lateral baffles 172x bound the transmitter 172 to define the range 176 (between the broken lines) of the light transmitted, as shown in FIG. 5E-3. Similarly, lateral baffles 173ax, 173bx bound the receivers 173a, 173b, respectively, to define the reception range 177a, 177b, as shown in FIG. 5E-1. The receivers 173a, 173b are arranged, for example, such that their reception ranges 177a, 177b overlap in an overlap region 177x, as shown in FIG. 5E-3.

FIGS. 5E-3 and 5E-4 show the gap sensor 156a in example operations. The gap sensor 156a is such that it can detect the gap, at distances of approximately 20-30 mm+/−15 mm from the gap, and gaps of as small as approximately 3 mm. For example, the transmitter 172 transmits light in a direction (e.g., downward) to a deck 180 formed by boards 181, with a gap or space 182 between the boards 181.

In FIG. 5E-3, a gap 182, represented by a gap displacement, is detected between the boards 181 (e.g., two adjacent boards), as the amount of reflected light (e.g., IR light) received by each of the receivers 173a, 173b is approximately equal (within a threshold) or equal. For example, the ratio of received (reflected) light to non-reflected light received is approximately equal (within a threshold) or equal. When the gap sensor 156a is in this position or orientation with respect to the gap 182, the robot 100 is considered to have acquired (e.g., determined, detected, found, or located) the gap 182, so as to be centered on or with respect to the gap 182, or aligned centrally or substantially centrally with respect to the gap 182.

In FIG. 5E-4, the amount of reflected light received is less for the first receiver 173a, than for the second receiver 173b. This is because the first receiver 173a is not receiving the maximum amount of reflected light, as part of the transmitted light is not reflected (received in the reception area 177a), as it is lost in the gap 182. This is in contrast to the second receiver 173b, which receives maximum reflected light, since its reception area 177b is completely over a board 181. For example, the ratio of received light to non-reflected light received is lower in the first receiver 177a, than the second receiver 177b, such that the gap 182 has not been acquired or otherwise found.

FIGS. 6A, 6B-1 and 6B-2 show an alternate staining system, which is, for example, modular. This staining system replaces the reservoirs 132 in with a single capsule or tank 200 (hereinafter “capsule”), which, for example, is removable (when the cover panel 102b is released, via button 107 and release mechanism 108A of FIG. 4). The capsule 200 fits into the payload 101 of the robot 100, and is refillable with, for example, stain, cleaner, coatings, and the like, or is a prefilled unit, with, for example, stain, cleaner, coatings, and the like. The capsule 200 also includes an opening or port portion 231a to receive the turbine 130, or a conduit with air flowing from the turbine 130. The capsule 200 includes a reservoir 232, formed for example, of two sections, which may be a single or multiple reservoirs (e.g., one reservoir for each sprayer 234), sprayers 234.

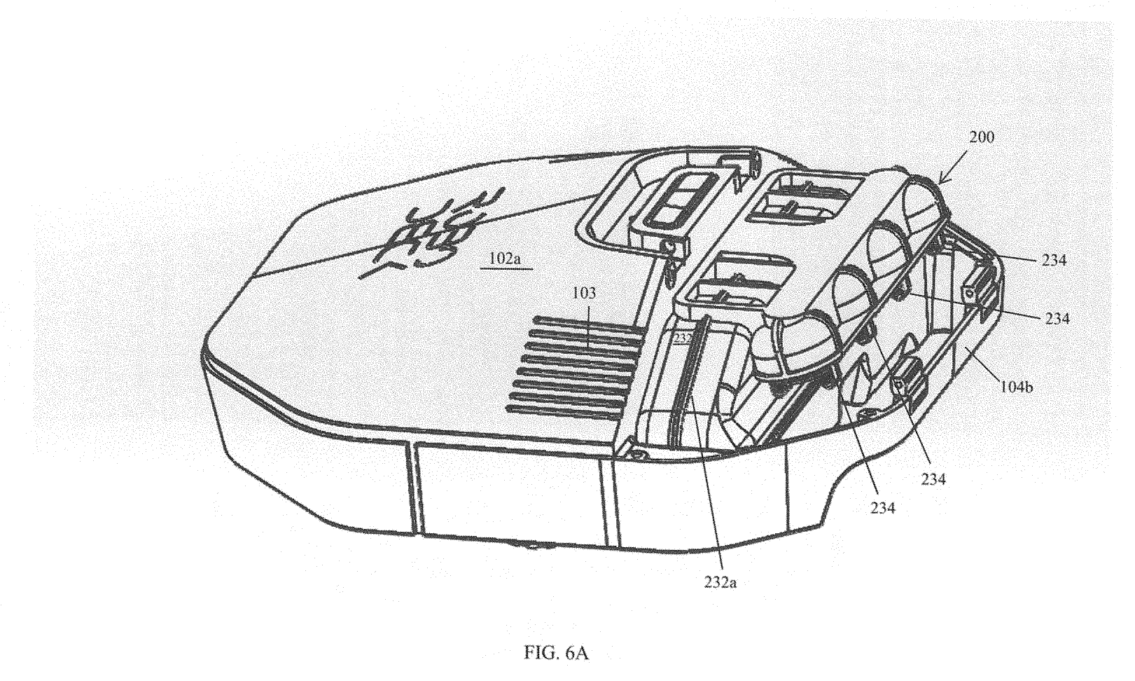

The sprayers 234 are similar in construction to the sprayers 134 detailed above. As shown in FIG. 6B-2, each sprayer 234 includes a nozzle 234a, through which the stain is sprayed. The nozzle 234a includes typically one aperture (liquid aperture) 234b, although plural apertures are suitable. Within the aperture 234 is a bump 234b1, to which the liquid, e.g., stain, moves along, prior to discharge as spray. The bump 234b1 is surrounded by an air chamber 234b2, which receives pressurized air (e.g., from one or more turbines 130) through the port portion 231a, over its own air line (not shown). This pressurized air is pressurized in order to atomize the stain (liquid) on the bump 234b1, such that a spray of the stain is discharged. Air apertures 234b3, 134b4 receive air from the port portion 231a of the conduit 131, over its own air line (not shown). The air flowing through the air apertures 234b3, 234b4 flattens the spray, so that it is discharges as an oval cone 236, as shown, for example in FIG. 7. This arrangement of the air flow in the capsule from the port portion 231a, to the air lines which carry the pressurized air to the air chamber 234b2, and the air apertures 234b3, 234b4, forms an air channel which is part of an air distribution system.

The capsule 200 includes an air distribution system, formed of the aforementioned air channel, and an additional air channel, separate from the aforementioned (turbine 130 fed) air channel. This additional air channel brings liquid, e.g., liquid stain, from the reservoir(s) 232 to the nozzle 234a. A pump, such as the pump 133, is connected to the reservoir 232, above the stain or liquid level, to pump pressurized air into the reservoir 232, to drive the stain or other liquid from the reservoir(s) 232 to the respective sprayer 234 (into the one or more nozzle chambers 234c), through the line or conduit 232a. The line or conduit 232a, for example, includes a valve (not shown), to control liquid flow therethrough. The pump 133 and valve 157a are part of the staining system 324, as controlled by the CPU 302 of the lower level controller 150a, as detailed for the robot 100 above. The pump 133, reservoir 232, line, and sprayers 234, e.g., the nozzle 234a and nozzle chamber 234c, form an air channel of the air distribution system for the capsule 200.

The sprayers 234 are arranged along the width of the capsule 200, for example, linearly. The sprayers 234 and their spacing and linear alignment provides spray coverage over the width of the robot 100, at the rear side 101r of the robot 100.

Alternatively, the capsule 200 is such that the reservoir 232 may be made of a flexible or deformable material. Accordingly, when the reservoir has pressure applied thereto, by a force applying member of the payload 101, fluid flows from the reservoir 232 to the at least one nozzle 234a, as detailed for the capsule 200 above.

FIG. 7 shows the robot 100 in a spraying/staining/coating operation. The robot 100 is shown moving forward, in the direction of the arrow 250. The brushes 112a, 112b, 112c perform the cleaning operation, in front of the staining unit 200, such that the stain is sprayed in jets 236 (of flattened or oval cones), after the brushes 112a, 112b, 112c have cleaned the surface of the deck boards.

FIG. 8A is a block diagram detailing the low level controller 150a. The low level controller 150a is, for example, processor controlled, by a processor, such as a central processing unit CPU 302 in wired communication with storage/memory 304. The CPU 302 is in communication with various sensors and detectors including odometers 311, deck board detection or gap (between the deck boards) sensors 156a, proximity/wall following sensors 156b, cliff sensors 156c, bumper sensors 156d, stain system sensors 156x including stain pressure detection 156e, air pressure detection 156f1, 156f2, and stain level in the reservoir/tank 156g, battery voltage and current sensors 156h, ambient temperature sensors 156i, and ambient humidity sensors 156j, and valves 157a, 157b. The CPU 302 also controls and coordinates with platform systems, the movement system (MS) 321, and the power system (PS) 322 (battery 140 and related electrical connections to robot components), and the payload 101 systems, the cleaning system (CS) 323, and the staining system (SS) 324. The CPU 302 is also in communication with the CPU 402 of the high level controller 150b, to coordinate the movement system 321, the power system 322, the cleaning system 323, and, the staining system 324, with the Mapping System 422 and the Navigation system 423 of the high level controller 150b.

The Central Processing Unit (CPU) 302 is formed of one or more processors, including microprocessors, for performing robot functions and operations detailed herein, including controlling the movement system 321, the power system 322, the cleaning system 323, and, the staining system 324, as well as communicating with the high level controller 150b (FIG. 8B). The Central Processing Unit (CPU) 302 processors are, for example, conventional processors, such as those used in servers, computers, and other computerized devices, including data processors, hardware processors and the like, for performing the robot 100 functions and operations detailed herein. For example, the processors may include and a micro controller unit (MCU), for example, an Advanced RISC Machine (ARM) based processor such as STM32FO/F4/F7.

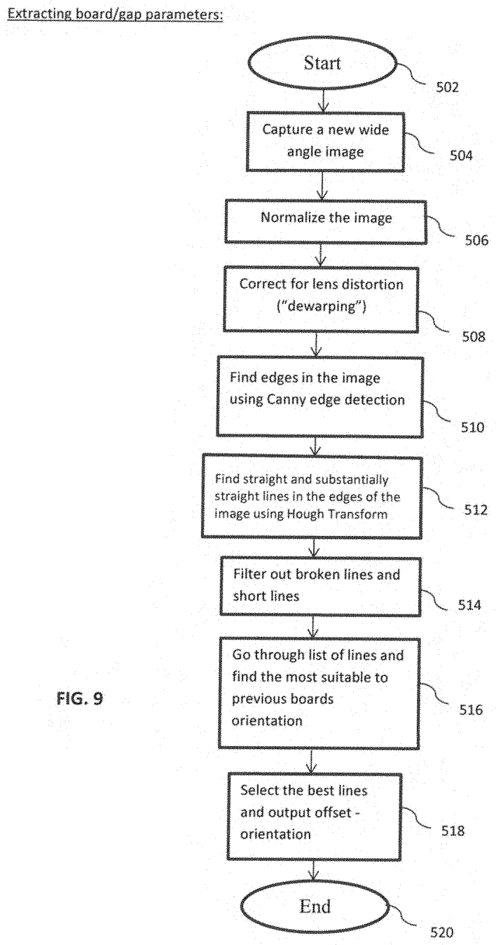

The storage/memory 304 is associated with the CPU 302 is any conventional storage media. The storage/memory 304 also includes machine executable instructions associated with the operation of the CPU 302 and the sensors 311, 156a-156j and the movement system 321, the power system 322, the cleaning system 323, and, the staining system 324, along with the processes and subprocesses shown in FIGS. 9-12, detailed herein. The processors of the CPU 302 and the storage/memory 304, although shown as a single component for representative purposes, may be multiple components, and may be positioned on the robot, outside of the controller 150a, 150b boards.

Odometers 311 are linked each of the drive wheels 120, for obtaining velocity and distance traveled by the wheels 120 of the robot 100. The CPU 302 uses this data, for example, with the movement system 321, cleaning system 323, and, the Staining System 324, to determine the distances of travel for activating and deactivating the cleaning system 323 and/or the staining system 324, in response to a distance traveled by the robot 100.

The bumper sensor 156d links to the CPU 302, which when a bumper event, e.g., a contact with an object, which depresses the front skirt 104a a predetermined distance is detected, causes the movement system 321 to stop movement of the robot 100.

The gap sensors 156a (shown in detail in FIGS. 5E-1 to 5E-4, and discussed above) sense gaps between deck boards, as the robot 100 moves. The sensed gap data is sent to the CPU 302, which controls the movement system 321, for example, to positon the robot 100 with respect to gaps in the deck boards, and when necessary, as a result of the gap being sensed, the CPU 302 will control the cleaning system 323 and/or the Staining System 324.

The proximity/wall following sensors 156b sense (detect) and follow walls on the deck, as the robot 100 moves. The sensed wall following data is sent to the CPU 302, which controls the movement system 323, for example, to positon the robot 100 with respect to the walls associated with the deck and its area, and when necessary, as a result of the walls being sensed, the CPU 302 will control the movement system 321, cleaning system 323 and/or the staining system 324.

The cliff sensors 156c sense drop offs, such as deck edges, encountered by the robot 100 as it moves. The sensed drop offs are sent to the CPU 302, which controls the movement system 321, to for example, stop or turn the robot 100.

The staining system sensors 156x are a combination of three sensors, 156e, 156f1, 156f2, 156g, all of which link to the CPU 302. The stain pressure detection sensors 156e detect spraying pressure for the stain as it leaves the reservoir/tank. The air pressure detection sensors 156f1 detect atomizing air pressure for spraying the stain, generated by the turbines 130, and the air pressure detection sensors 156f2, detect air pressure produces by the pump 133. The stain level sensing sensors 156g detects the amount of stain in the reservoir 132 and/or the capsule reservoir 232. For example, should a predetermined “low” level of stain be in the reservoir/tank, the CPU 302 may signal the staining system 324 to stop, and the movement system 321 to stop or return the robot 100 to a predetermined location for a replacement tank or refilling of stain into the tank 232. For example, refilling may occur at a base station, which the robot is programmed to seek, return to, and dock at, should the battery voltage go below a predetermined threshold, as detected for example by the sensor 156h. The CPU 302 also controls valves 157a, 157b in the reservoir 132/232 to control the amount of stain being sprayed onto the deck boards.

The battery voltage sensor 156h detects the voltage or charge (e.g., capacity gauging of the BMS 322a) of the battery 140. This information is transmitted to the CPU 302. Should the voltage or charge be at or below a threshold voltage or charge, the CPU 302 signals the movement system 321 to stop or return the robot 100 to a predetermined location for recharging or battery replacement. The cleaning system 323 and/or staining system 324 if operating, may also stop, while the robot 100 stops or returns to the predetermined location for charging or battery replacement.

The temperature sensors 156i, located within the robot payload 101, sense ambient temperature with respect to the robot 100, and transmit temperature data to the CPU 302. The CPU 302 may adjust components of the staining system 324, based on detected temperature.

The humidity sensors 156j, located within the robot payload 101, sense ambient humidity with respect to the robot 100, and transmit humidity data to the CPU 302. The CPU 302 may adjust components of the staining system 324, based on detected humidity.

FIG. 8B is a block diagram detailing the high level controller 150a. The high level controller 150a is, for example, processor controlled, by a processor, such as a central processing unit CPU 402 in wired communication with storage/memory 404. The CPU 402 is, for example, a multi-core processor, such as a NVIDIA™ nano RPi4. The storage/memory 404 is similar to the storage/memory 302 as detailed for the low level controller 150a. The CPU 402 is in communication with the inertial measuring unit (IMU) 153 and the communications interface 154, which facilitates communications over WiFi® and/or other on-line links to and from the high level controller 150a of the robot 100.

The CPU 402 is in communication with the camera 152, the mapping system 422, and the navigation system 423. The mapping system 422 and navigation system 423 are running algorithms within the within the CPU 402 of the high level controller 150b. The CPU 402 is also in communication with the CPU 302 of the low level controller 150a, to integrate the a camera 152, a mapping system 422, and a navigation system 423, with the movement system 321, power system 322, cleaning system 323, and staining system 324, controlled by the CPU 302 of the low level controller 150a. The high level controller 150a is powered by the battery 140 of the power system 322.

The IMU 153 is a sensor that includes, a magnetometer, gyrometer and an accelerometer, to detect, for example, robot 100 directional movement, tilt, velocity and acceleration. These detected parameters are transmitted from the IMU 153 to the CPU 402, which to allow for adjustments in the mapping system 422, navigation system 423, as well as the movement system 321, cleaning system 323, and staining system 324.

The communications interface 154 supports wireless communications between the robot 100 and controlling devices, such as computers, smart phones and other computerized devices over both local area networks (LAN) (e.g., enterprise networks) and wide area networks (WAN), such as the Internet and cellular networks.

The camera 152 collects images of the area in front of and lateral to the robot 100, and is typically equipped to process the obtained images, which may be in the form of video and/or still images. These images are transmitted to the CPU 402, where they are processed. The processed images allow for the creation of maps, by the mapping system 422, as well as setting up navigation patterns, such as traversing or scanning patterns for the robot 100, by the navigation system 423 for the movement of the robot 100 by the movement system 321. Data from the camera 152, IMU 153, and the maps, generated by the mapping system 422, are analyzed by the navigation system (NS) 423, for creating a course of movement for the robot 100 to stain and, when necessary, prior to staining, clean the deck (dirt, debris and material, including particulate, removal). The navigation system (NS) 423 provides the travel (traversal or scanning) route for the robot 100 along the deck, by signaling a pattern of movement for the mapped area or work area to the drive wheels 120, so that the robot 100 applies the stain in accordance with a predetermined movement pattern.

The camera 152, for example, also serves as a gap sensor, a proximity sensor (e.g., for proximity to objects and obstacles), and a boundary detection sensor. The camera 152 images, when used, for example, for obstacle detection, and gap sensing between deck boards, affects the mapping system 422, the navigation system 423, and the navigation system's control of the movement system 321. With the camera images processed, the CPU 402 also controls the movement system 321 to respond to detected obstacles and avoid them, as well as positioning the robot 100 with respect to a detected gap between boards.

Attention is now directed to FIGS. 9-12, which show flow diagrams detailing computer-implemented processes in accordance with embodiments of the disclosed subject matter, for operation of the robot 100. These computer-implemented processes include, extracting board parameters, moving along the board (board traversal), moving from board to board, and mapping. These processes allow for the robot to efficiently stain, clean, and/or otherwise coat the boards of a deck with a material, and/or, clean the deck of dirt and debris. Reference is also made to elements shown in FIGS. 1 through 8B, which perform processes detailed in the flow diagrams of FIGS. 9-12. The aforementioned processes and sub-processes are, for example, performed automatically and in real time, and some portions of the processes may be manual.

FIG. 9 is an example process for extracting board/gap parameters, so that the robot 100 can maneuver/work within a mapped area, e.g., of the work area, with respect to the deck boards, and the location of the robot 100 with respect to the deck boards of the mapped area is known. This allows the robot 100 to localize itself with respect to the board, by moving along the deck boards, and maneuver with respect to the board, even before the area is mapped.

The process begins at a START block 502, where the robot 100 is operating and the cleaning or staining systems may be active or inactive. Moving to block 504, the camera 152 captures an image, for example, still images and/or video, of an area forward of the robot 100, including the areas above and below the robot 100. These images, for example, are low resolution images, for example, 640×480 pixels, to minimize CPU 402 computing power and memory.

At block 506, the image is normalized, to bring the image within a standard range of color, shading, brightness, and other image parameters. From the normalized image, the board heading and offset is obtained. The board heading is the angle between the robot 100 and the boards, and the offset is the lateral position of the robot with regard to the gap axis.

The process moves to block 508, where the central section of the normalized image is cut, for example, into sections preprogrammed into the CPU 402, for CPU 402 resources optimization, and management of the CPU 402 memory. The image is corrected for camera lens distortion or dewarping. Dewarping is used to regain straight lines as the camera transforms straight lines into spheres.

The process moves to block 510, where edges in the dewarped image, such as natural edges or boundaries of the boards, are found using methods such as Canny edge detection. Moving to block 512, straight and/or substantially straight lines in the image, are found by applying a Hough Transform to the edges detected in the camera 152 image. The Hough Transform is used to extract the parameters of all lines that exist in the edges image. Those parameters would be used to find the board's edges. Short lines, of a length below a predetermined length, and broken lines, for example, those that do not extend straight or substantially straight, are filtered out of the image, at block 514.

The process moves to block 516, where the remaining lines are analyzed to find the lines most suitable or similar to those of a previous board image orientation. At block 518, the most suitable or best lines are selected, to determine the correct board on which to start working (traversing). For example, a single line, corresponding to the board's edge, or two lines, in case both adjacent edges are detected, are used. Also at block 518, the latest correction of the location with respect to the boards is determined. The process moves to block 520, where it ends.

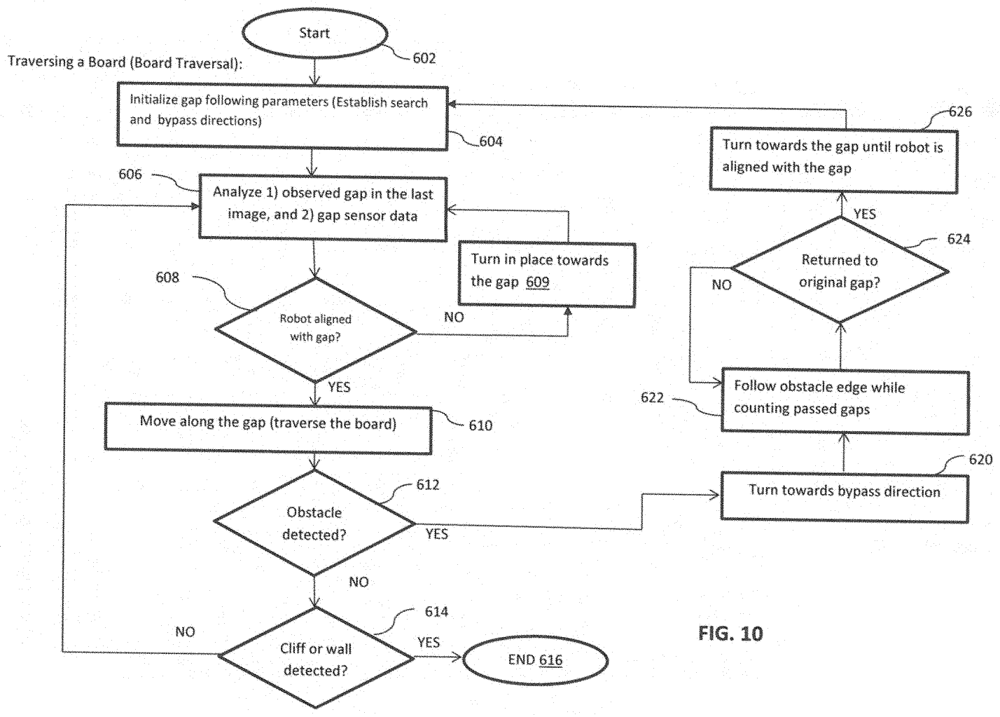

With the board determined and gap parameters established, the navigation of the board may now occur. Attention is directed to the flow diagram of FIG. 10, where an example process for traversing a board or boards, if adjacent boards of a deck are being moved along or traversed, is described.

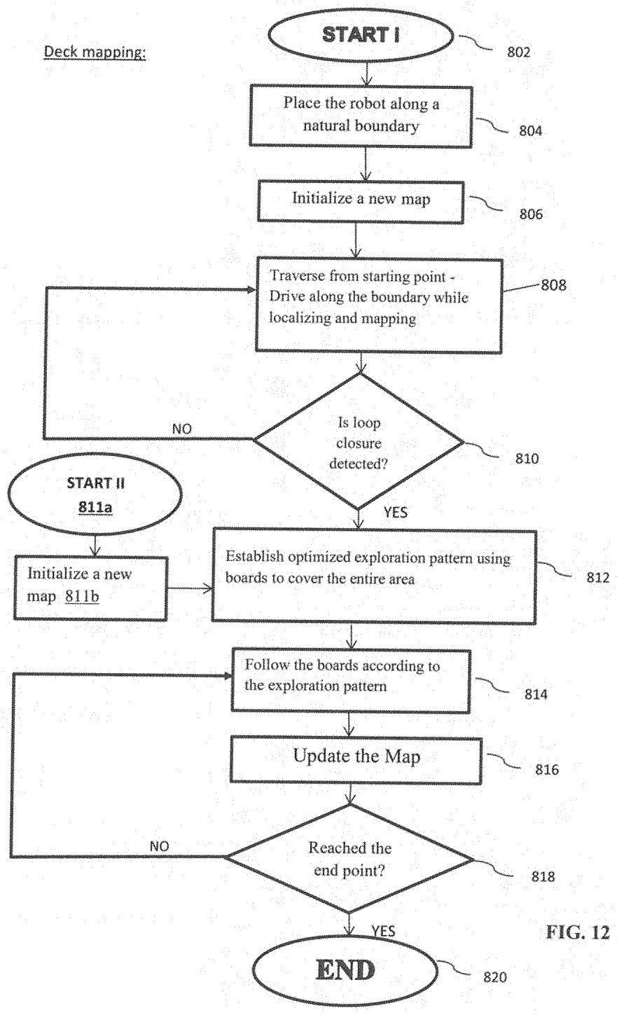

The process begins at a START block 602. At block 602, the robot has mapped or otherwise determined the deck areas where it has traveled, and typically cleaned and/or stained, for example, according to the mapping process of FIG. 12 below. This data is used in establishing the bypass direction detailed for this process below.

Moving to block 604, the gap following parameters are initialized and the parameters are followed. This gap initialization includes, for example, knowledge by the CPU 402 of the areas of the deck which have been cleaned and/or stained, such that the robot 100 does not travel over these areas if forced to deviate on its path due to detection of an obstacle. This knowledge results in parameters, which include establishing a bypass direction, as determined by the CPU 402, for example, based on maps including worked or stained areas, should an obstacle be encountered.

The process moves to block 606, where a gap between the boards is determined or acquired. The gap is, for example, determined from the previous camera image (obtained from the camera 152) and/or the gap sensor data (obtained from the gap sensor 156a).

The process moves to block 608, where the gaps are determined or acquired, as the robot 100 turns in place until the robot aligns with the gap. The alignment is, for example, such that the robot is positioned centrally or substantially centrally with respect to the gap. This positioning corresponds to the gap being centered or substantially centered with respect to the robot 100 in the present image, or detected as such, by the gap sensors. However, the alignment may also be such that the robot 100 is positioned laterally with respect to the detected gap (e.g., the gap being a point of reference for the robot 100). Should a central (or substantially central) alignment of the robot 100 with respect to the gap be desired and programmed into the robot 100, as is typical, until the gap is centered in the image or detected by the gap sensor as central or substantially central with respect to the robot 100, at block 608, the robot turns in place toward the gap, at block 609, until the robot is aligned, for example, so as to be positioned centrally or substantially centrally with respect to the gap, at block 608.

At block 608, once the gap is detected or acquired, and, for example, centered (or substantially centered) in the present camera image, and/or by the gap sensor 156a, the process moves to block 610. At block 610, the robot 100 moves forward (e.g., along the gap) with the gap (previously centrally or substantially centrally aligned with respect to the robot 100) being kept centered (or substantially centered) in the present camera image and/or as detected by the gap sensor 156a. The process moves to block 612, where it is determined, for example, by the camera 152 acting as an obstacle detector (sensor), or the proximity sensor 156b detects an obstacle in the direction of travel of the robot 100. Alternately, the obstacle may be determined by a bumper event, via the bumper sensor 156c.

At block 612, should an obstacle be detected, the process moves to block 620, where the robot 100 turns toward the bypass direction, set in the CPU 302. The process moves to block 622, where the robot 100 follows the obstacle edge while continuing past the gaps in the deck boards. The robot 100, either from camera images or gap sensor 156a data, detects and counts gaps, as it traverses along the edge of the obstacle, and sends this data to the CPU 402 and navigation system 423. The process continues to block 624, where it is determined whether the robot 100 has reached (returned to) the original gap, from the camera image of block 608 and/or gap sensor data, an analyzed by programs in the CPU 402. If no at block 624, the process returns to block 622, from where it resumes. If yes at block 624, the process moves to block 626, where the robot 100 turns toward the gap, until the robot 100 is aligned with the gap, for example, the robot positioned centrally or substantially centrally with respect to the gap (as determined from the camera image and/or gap sensor data). The process then moves to block 604, from where the process resumes.

Returning to block 612, should an obstacle not be detected, the process moves to block 614. At block 614, it is determined whether a cliff or a wall has been detected, for example, by the cliff/wall sensor 156c, via the CPU 302 and programs running in the CPU 302. If no at block 614, the process moves to block 606, from where it resumes. If yes, the process moves to block 616, where the robot 100 stops and the process ends.

The process of moving along (e.g., traversing) a board (or boards, if adjacent boards of a deck are being moved along or traversed) may be performed for as long as necessary. The process may continue, for example, as the robot 100 moves to the next or subsequent board(s). The process may end, for example, should the robot 100 stop moving.

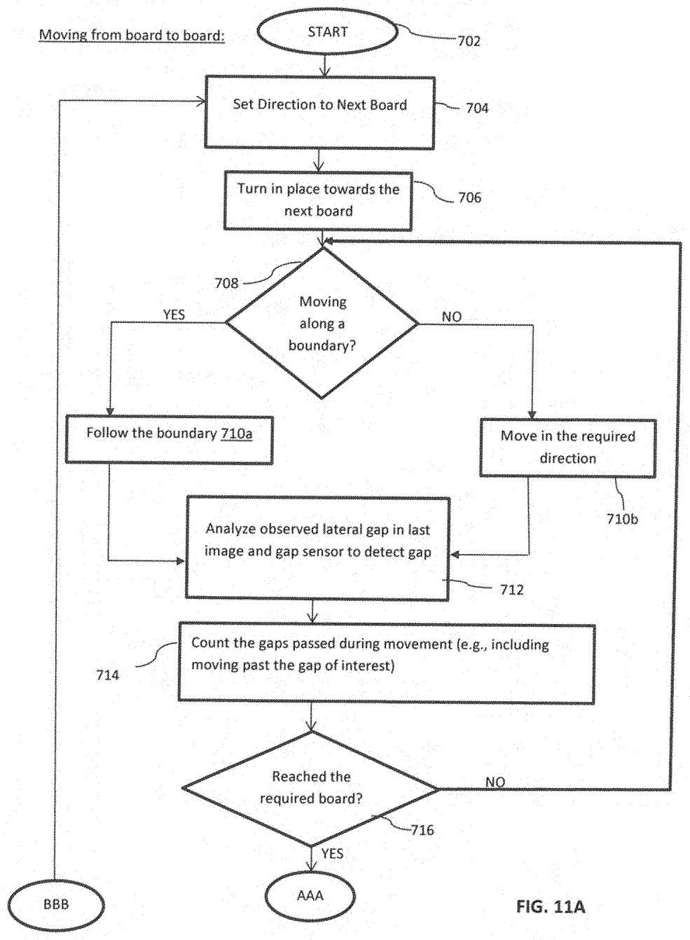

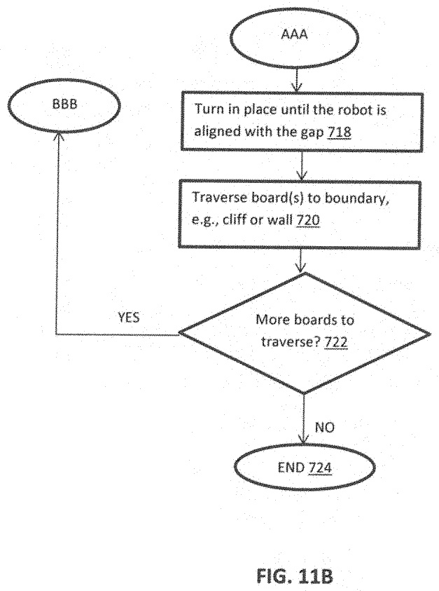

With at least one board, for example, two adjacent boards, spaced apart from each other of the deck, having been traversed, the robot 100 moves to the next or subsequent board of the deck for cleaning and/or staining. Attention is directed to the flow diagram of FIG. 11, where an example process for moving from one board (e.g., at least one board but typically two adjacent deck boards) to another board (e.g., at least one board but typically two adjacent deck boards).

The process begins at a START block 702, where the robot 100 has or is following, for example, at least one board but typically two adjacent deck boards, as per the board traversal process of FIG. 10, and, for example, the robot 100 has reached a boundary, for example, a cliff or a wall associated with the deck. The robot 100 is, for example, centered (e.g., aligned) with respect to the gap and/or the board. Moving to block 704, the direction of the next/subsequent board is set, for example, based on the boards of the map. A heading is set tangential to the board.

At block 706, the robot 100 turns in place toward the next board, turning 90 degrees or approximately 90 degrees (e.g., approximately tangential to the board's heading). The process moves to block 708, where robot 100 begins moving, and the CPU 302 associated with the cliff and wall sensor 156b, and/or the CPU 402 associated with the camera 152, determines whether the robot 100 is moving along a boundary of the deck. Should the robot be following the boundary, the process moves to block 710a, and the process moves to block 712.

At block 708, if the robot 100 is not moving along a boundary (for example, tangential to the boards), as there is no distinct boundary, the process moves to block 710b. At block 710b, the robot 100 moves in the required direction, and the process moves to block 712

At block 712, the observed lateral gap in the last or previous camera image and/or gap sensor data is analyzed, for example, in order to determine the number of gaps and/or boards the robot 100 has passed. The process moves to block 714, where the gaps passed during the robot movement are counted. This counting, for example, includes the robot 100 passing the gap of interest (the gap of the corresponding board the robot 100 is to traverse next), to determine the next board to be traversed.

The process moves to block 716, where it is determined whether the robot 100 has reached the requisite board, based on the number of gaps counted. If not enough gaps have been counted, based on the gaps established upon mapping the work area, the process moves to block 708, from where it resumes. If the correct number of boards has been counted at block 716, the process moves to block 718.

At block 718, the robot turns in place, for example, 90 degrees, or approximately 90 degrees, until the gap is aligned, for example, the robot 100 is positioned centrally or approximately (substantially) centrally, with respect to the gap. The centering may be within camera 152 image(s), or determined by the gap sensor 156a.

The process then moves to block 720, where the robot moves, following the gap, as described for the Board Traversal process of FIG. 10 above. The traversal (robot moving along the board or adjacent boards, for example, two adjacent boards) is, for example, to a boundary of the deck, such as a cliff or a wall. At this point, for example, based on the map or camera image, the robot 100, at block 722, via the CPU 402, determines whether there are more boards (area) of the deck to traverse.

At block 722, should there be more boards to traverse, the process moves to block 704, from where it resumes as detailed above. Should there not be any more boards to traverse, the process moves to block 726, where it ends. The process may be repeated for as long as is necessary or desired.

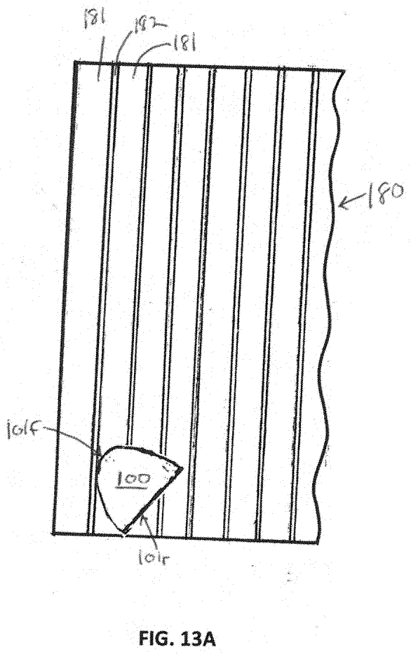

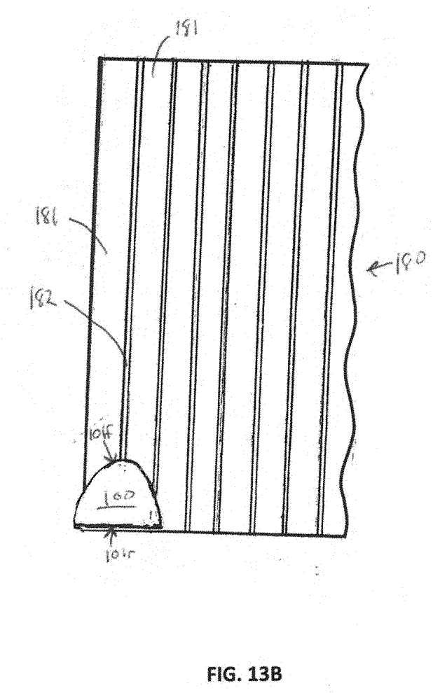

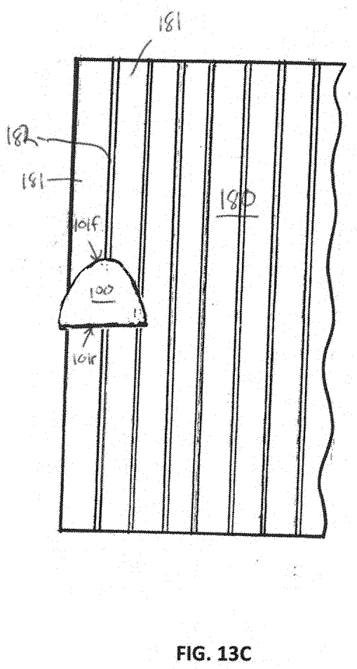

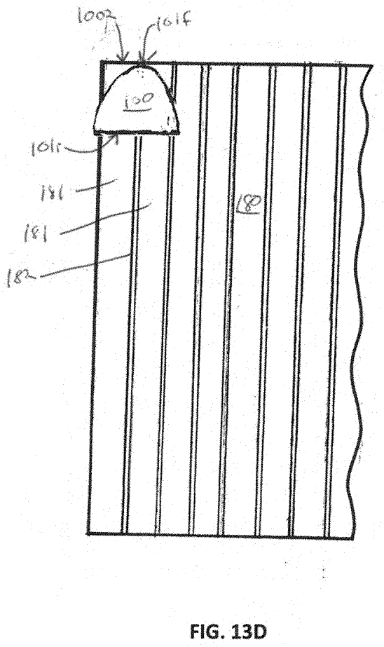

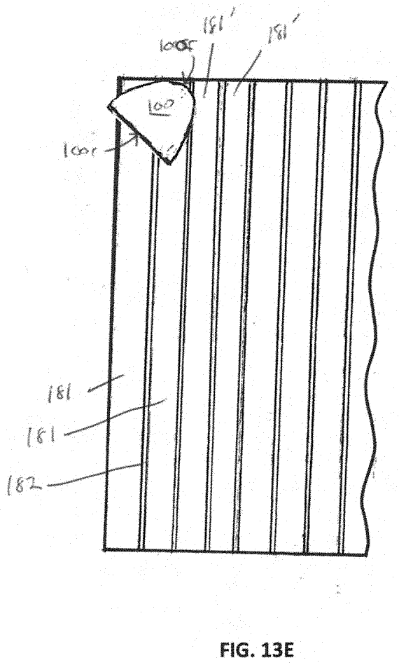

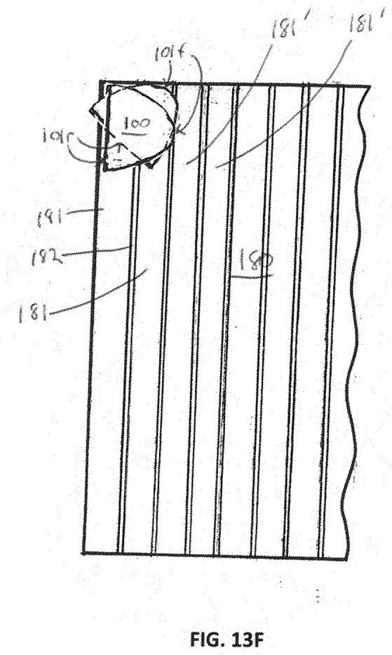

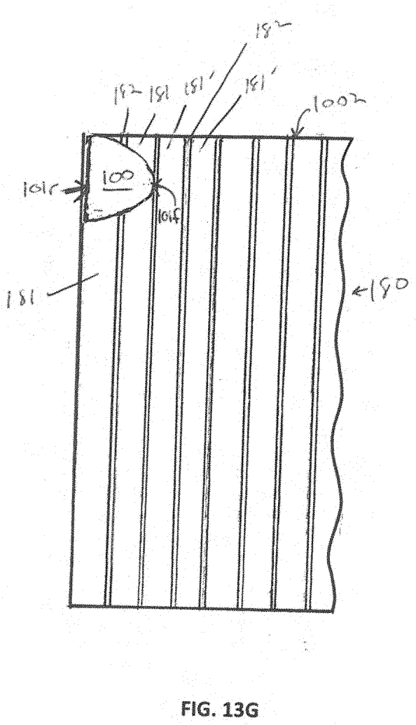

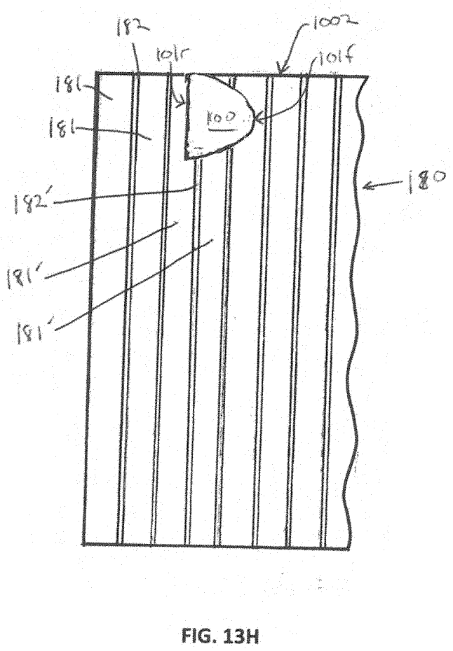

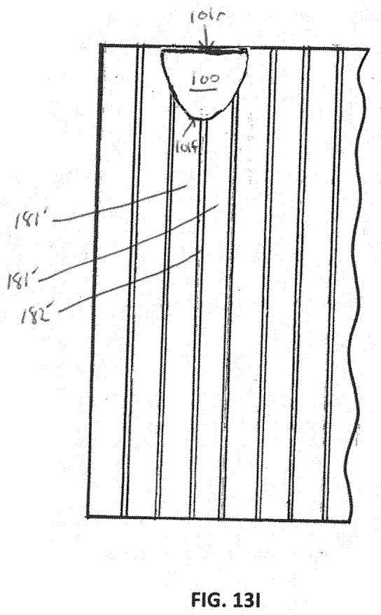

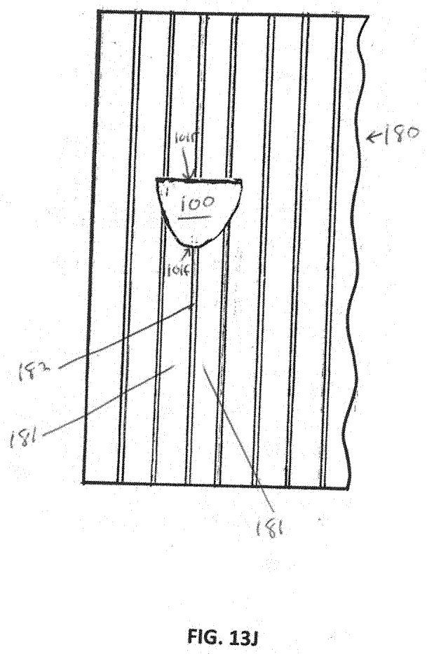

FIGS. 13A-13J show an example operation of the robot performing a board traversal on a deck 180, with spaced apart boards 181 having a gap 182 between the boards 181 (FIG. 13A). In accordance with the process of FIG. 10, followed by moving from board to board, in accordance with the process of FIGS. 11A and 11B. In FIGS. 13A-13J, a number marked with a prime (′) to show action at or proximate to the specific prime numbered component.

Initially, the robot 100, as shown in FIG. 13A moves to find a board 181, as programmed into the navigation system, or the CPU 402. Having found a board (or boards) 181, the robot 100 finds the gap 182, and aligns with the gap 182, as shown in FIG. 13B. This alignment is such that the robot 100, for example, is positioned centrally or substantially (approximately) centrally with respect to the gap 182.

Having found, or otherwise determined, the gap 182, the robot 100 moves along the board(s) 181, following the gap 182, maintaining the alignment, e.g., centrally or substantially centrally positioned, with respect to the gap 182, and the robot 100, for example, continues to determine the gap 182, as shown in FIG. 13C. The robot 100 may be staining, cleaning and/or coating the deck surface during this movement.

The robot 100 continues its movement, until it reaches a boundary 1002, where it stops, as shown in FIG. 13D. Should the robot 100 be staining, cleaning and/or coating the deck 180 at this time, for example, staining would temporarily stop, so this spot on the deck 180 is not overstained. Staining resumes when a new board (or boards) is/are acquired.

The robot 100 now begins to turn in place, at FIG. 13E, in order to begin acquisition of the next board (or boards) 181′ for traversal. The turn continues, in FIG. 13F, and is complete, when the robot 100 has turned 90 degrees or approximately 90 degrees, and is for example, perpendicular to the gap 182, as shown in FIG. 13G.

In FIG. 13H, the robot 100 continues by resuming movement, for example, following the boundary 1002, past the gap of interest 182′, for the next board 181′ (or boards) to be acquired. The staining system remains temporarily off.

The robot 100, as shown in FIG. 13H, now begins to turns in place, turning 90 degrees, or approximately 90 degrees to determine (find) the gap 182′. The turning continues until the robot 100 has determined (found) the gap 182′ and aligns with the gap 182′, as shown in FIG. 13I. This alignment is such that the robot 100, for example, is positioned centrally or substantially (approximately) centrally with respect to the gap 182′.

In FIG. 13J, the robot, 100, has found, or otherwise determined, the gap 182, and the robot 100 moves along the board(s), following the gap 182, maintaining the alignment, e.g., centrally or substantially centrally positioned, with respect to the gap 182, and continuing to determine the gap 182. Once moving along the board(s) 181, the robot 100 resumes its staining, cleaning and/or coating operations.

FIG. 12 is a flow diagram of an example process for mapping decks, performed, for example, by the CPU 402 and Storage/Memory 404 in conjunction with the camera 152, mapping system 422, and the navigation system 423. The process starts at a START (START I) block 802, where the robot 100 is operating with the cleaning 323 and staining 324 systems, for example, inactive.

The process moves to block 804 where the robot 100 is placed, or driven to, a natural boundary, such as an edge of the deck, e.g., a cliff or proximity thereto, or anywhere within the deck, such that the robot 100 can follow a board to its boundary. At block 806, a new map is initialized by the mapping system 422, for example, in the storage/memory 404 associated with the CPU 402.

Moving to block 808, the movement system 321 of the robot 100, moves the robot 100 along the boundary of the deck, as sensed by the camera 152, acting as a gap sensor, and a side proximity sensor 156b (e.g., with respect to objects on or over the deck), as well as the CPU 402 (via CPU 302) receiving data from the gap 156a and cliff 156c sensors, while localizing and mapping an area of the deck, to be worked or stained, known as a “work area”.

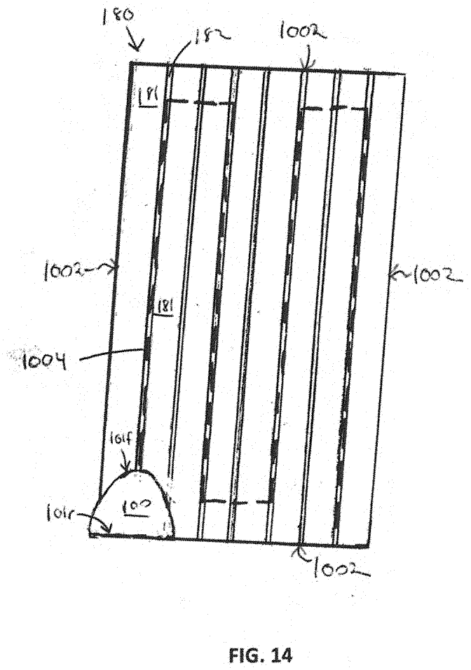

The process moves to block 810, where it is determined whether the robot 100 has traveled in an entire loop around the boundary 1401 (FIG. 14), e.g., a closed loop, where the robot 100 returns to its starting point or approximately thereto, such that a work area, bounded by the closed loop, is determined for the robot 100. If a closed loop has not been made by the robot 100, the process moves to block 808, from where it resumes. If the closed loop is complete, the process moves to block 812.

At block 812, an initial map is now made of the work area of the closed loop and the CPU 402 establishes a pattern, for example, an optimized exploration pattern (optimal in the sense of minimal time, minimum expected mapping errors, and the like), for the robot 100 in the work area (which is now mapped based on its boundaries). The pattern uses the deck boards to cover the entire mapped area, from an established starting point to an established end point. The optimization of the pattern is, for example, for minimizing time traveled, minimal expected mapping errors, and the like, and one such pattern, for example, an optimized pattern, is shown for the robot 100 traveling over a deck 180, within the deck boundaries 1002, with the travel pattern in broken lines 1004, in FIG. 14. The starting point and the end point, while typically different, may also be the same or approximately the same point. The pattern 1004 is, for example, programmed into the CPU 402. The CPU 402 sends the exploration pattern to the navigation system 423, which, in turn causes the movement system 321 of the robot 100 to move the robot in accordance with the pattern. Remaining in FIG. 14, the map may be broken into subsections (of the work area) due to the shape of the deck 180 and its boards 181, with gaps 182 between the boards 181.

The process moves to block 814, where the robot 100, as driven by the movement system 321, in accordance with the pattern of the navigation system 423, follows the deck boards, and moves from board to board in accordance with the exploration pattern. During this movement, the robot 100 camera 152 may be imaging the areas of the deck being traversed, with these images being used to update the map, at block 816. While the robot 100 is moving along the exploration pattern, the robot 100 location on the map is localized or updated, and the map itself is updated by the simultaneous localization and mapping (SLAM) algorithm, the Visual SLAM (VSLAM) algorithm, and/or the camera images of the area (e.g., of the deck) traversed, at block 816.

For example, the map may be updated continuously as the robot traverses the deck by the mapping system 422 continuously determining the area covered (traversed) by the robot 100, and adding this area to the map continuously or “on the fly”, corresponding to the robot 100 traversing the deck. The map may also be updated at time intervals set by the robot as it traverses (travels) along the deck, or updated when the robot reaches first and subsequent junctures, the junctures defined, for example, by the robot 100 traveling, a predetermined distance (as determined by the odometers 311), for a predetermined time (e.g., a time interval), a location or position on the deck, which may be predetermined, or, when the robot has reached a boundary, new deck board(s).

The process moves to block 818, where it is determined whether the robot 100 has reached the end point. If no, the process moves to block 814, from where the process resumes. If yes, the process moves to block 820, where it ends. The process is repeatable for as many iterations as desired.

Alternately, the process may start at the START II block 811a. At this START block 811a, the robot 100 is placed anywhere within the deck and follows the board to its boundary, for example, a cliff or a wall, in accordance with the process of Traversing A Board of FIG. 10. The process then moves to block 811b, where a new map is initialized robot 100 a new map is initialized by the mapping system 422, for example, in the storage/memory 404 associated with the CPU 402 (similar to that for block 806).

The process moves to block 812, where in this case, the CPU 402 controls the robot 100, as the navigation system 423 instructs the movement system 321 to explore the deck, for example, by following boards (as per FIG. 10), until there are not any unexplored areas of the deck.

From block 812, the process moves to block 814, from where it resumes (performing the processes of blocks 816 and 818) as above. The process ends at block 820, as detailed above.

The flowcharts and block diagrams in the Figures illustrate the architecture, functionality, and operation of possible implementations of systems, methods and computer program products according to various embodiments of the disclosed subject matter. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosed subject matter have been presented for purposes of illustration, but are not intended to be exhaustive or limited to the embodiments disclosed. Many modifications and variations will be apparent to those of ordinary skill in the art without departing from the scope and spirit of the described embodiments.

The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable subcombination or as suitable in any other described embodiment of the disclosed subject matter. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the disclosed subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for traversal of a deck by an autonomous robot, the deck formed of spaced apart boards including a gap between the boards, the method comprising:
the robot traversing at least one board by following a gap between the at least one board and another adjacent board;
determining the gap, by the robot during the traversing to maintain the robot in alignment with respect to the first gap; and,
the robot responding to the determining the gap by the robot moving along the at least one board to maintain alignment with respect to the gap during the traversal.

2. (canceled)

3. The method of claim 1, wherein the alignment with respect to the gap includes the robot being positioned substantially centrally with respect to the gap.

4. The method of claim 1, wherein the determining the gap is performed using one or more of: a camera of the robot, and/or a gap sensor of the robot, the gap sensor including at least one light transmitter and reflected light receivers.

5. (canceled)

6. (canceled)

7. The method of claim 1, wherein the robot traversing the at least one board includes the robot moving dirt and debris one or more of: 1) inward with respect to the robot such that the dirt and debris is pushed into the gap, 2) outward with respect to the robot, such that dirt is pushed over the boundary of the deck, and/or into zones located on the deck.

8. The method of claim 1, wherein the robot traversing the at least one board includes the robot staining the deck.

9. The method of claim 8, wherein the staining includes spraying stain from at least one nozzle.

10. The method of claim 10, wherein the at least one nozzle includes a plurality of nozzles arranged adjacently with respect to each other, and extending widthwise along the robot.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. A sensor for detecting gaps between spaced apart boards in a deck, comprising:
at least one transmitter for transmitting energy in waves;
a first receiver for receiving reflected energy waves transmitted from the at least one transmitter, the first receiver including a first reception range;
a second receiver for receiving reflected energy waves transmitted from the at least one transmitter, the second receiver including a second reception range; and,
the first reception range and the second reception range adjacent to each other;
wherein based on the amount of reflected energy received in each of the first receiver and the second receiver, a gap displacement is detected between two spaced apart boards in a deck.

55. The sensor of claim 54, wherein the adjacent first and second ranges include at least one overlapping portion.

56. The sensor of claim 54, wherein the transmitter is intermediate to the first and second receivers.

57. (canceled)

58. The sensor of claim 54, wherein the transmitted energy in waves from the at least one transmitter include infrared (IR) light, and the first receiver and the second receiver are configured to receive the energy waves including IR light.

59. (canceled)

60. (canceled)

61. The sensor of claim 54, wherein the gap is determined to be centered when the light energy received by the first receiver and the second receiver is at least approximately equal.

62. (canceled)

63. (canceled)

64. A capsule for removably attaching to a payload of a robot comprising:
a reservoir;
at least one nozzle;
a conduit in communication with the reservoir and the at least one nozzle, in which fluid flows from the reservoir to the at least one nozzle; and,
an air system in communication with the at least one nozzle for receiving pressurized air from a pressurized air source, the pressurized air for atomizing the fluid, creating a spray.

65. The capsule of claim 64, wherein the at least one nozzle includes one or more openings to the ambient environment through which the fluid flows prior to atomization.

66. (canceled)

67. The capsule of claim 64, wherein the reservoir is prefilled with fluid.

68. (canceled)

69. The capsule of claim 64, wherein the at least one nozzle includes a plurality of nozzles spaced apart from each other to extend widthwise with respect to the robot.

70. (canceled)

71. (canceled)

72. The capsule of claim 64, wherein the conduit is configured such that external pressure on at least a portion of the conduit causes fluid to flow from the reservoir to the at least one nozzle.

73. The capsule of claim 64, wherein the portion of the capsule including the reservoir is of a flexible material which moves inward when a force is applied thereto, causing the fluid to flow to the at least one nozzle.

74. The capsule of claim 64, additionally comprising:
a channel in communication with the reservoir, and a pressurized air source, such that when pressurized air is received from the pressurized air source, fluid flows from the reservoir to the at least one nozzle through the at least one channel.

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)
